(19) United States
(12) Patent Application Publication
(10) Pub. No.: US 2023/0403475 A1
(43) Pub. Date: Dec. 14, 2023

(54) REFLECTION REFUTING LASER SCANNER

(71) Applicant: Path Robotics, Inc., Columbus, OH (US)

(72) Inventors: William HUANG, Dublin, OH (US); Animesh DHAGAT, Columbus, OH (US); Tarushree GANDHI, Columbus, OH (US); Jason ROBINSON, Columbus, OH (US); Alexander James LONSBERRY, Gahanna, OH (US)

(73) Assignee: Path Robotics, Inc., Columbus, OH (US)

(21) Appl. No.: 18/331,604

(22) Filed: Aug. 29, 2023

Related U.S. Application Data
(60) Provisional application No. 63/350,351, filed on Jun. 8, 2022.

(51) Int. Cl. H04N 23/75; H04N 23/56; H04N 23/71; G01S 17/89; G01S 7/481

(52) U.S. Cl. CPC H04N 23/75; H04N 23/56; H04N 23/71; G01S 17/89; G01S 7/4814

(57) ABSTRACT

This disclosure provides systems, methods, and apparatuses, including computer programs encoded on computer storage media, that provide for optical techniques for manufacturing robots, such as for filtering certain reflections when scanning an object. For example, the techniques may include receiving, from a detector, sensor data based on detected light, the detected light including reflections of light projected by one or more emitters and reflected off of an object. The techniques may further include determining, based on the sensor data, a first-order reflection and a second-order reflection. The techniques may also include determining, based on the first-order reflection and a second-order reflection, a difference, the difference includes a polarity difference, an intensity difference, or a combination thereof. The techniques may include filtering the second-order reflection based on the difference Other aspects and features are also claimed and described.

### CROSS-REFERENCE TO RELATED APPLICATIONS

This application claims the benefit of U.S. Provisional Patent Application No. 63/350,351, entitled, “REFLECTION REFUTING LASER SCANNER,” filed on Jun. 8, 2022, which is expressly incorporated by reference herein in its entirety.

### TECHNICAL FIELD

Aspects of the present disclosure relate generally to the field of optical systems and methods, and more particularly, but not by way of limitation, to optical systems and methods for rejecting certain reflections when scanning an object, such as optical systems that include a reflection refuting laser scanner or methods that use a reflection refuting laser scanner. Aspects of the present disclosure also relate generally to digital representations of scanned objects.

### INTRODUCTION

Laser scanners generally operate by projecting a laser line and capturing images (e.g., using cameras) of a reflection of the laser line. For example, a laser line may first be projected from the laser scanner onto an object. The object—while having laser lines projected thereon—may then be imaged (e.g., one or more images of the object may be taken) using the camera. A controller, which may be coupled to the scanner, may then receive the images and generate a digital representation (e.g., 3D model) of the scanned object. The digital representation is said to be most accurate if the captured image predominantly includes first-order reflections (e.g., reflected light that experiences only one reflection at the object).

Known laser scanners are generally suitable for flat objects or objects having very low reflectivity; they are generally unsuitable for more complex, curved, and/or reflective objects. To illustrate, if a laser line is projected onto a reflective object (either curved, or complex), such an object is likely to cast multiple reflections, it may be extremely difficult (and in some cases impractical) for the controller to accurately generate a digital representation of the object. For example, if a laser line is projected onto a curved reflective object, the object is likely to cast multiple reflections (e.g., first-order, second-order, and/or higher-order reflections), the detector captures (e.g., via one or more images) the multiple reflections. Capturing images including the multiple reflections—in-turn—would make it difficult for the controller to differentiate between the actual/desired signal (e.g., first-order reflections) and superfluous signals (e.g., second- or higher-order reflections, i.e., light that experiences more than one reflection). Inaccuracies in a digital representation of an object may propagate based on additional processing that uses or relies on the digital representation. For example, robotic manufacturing may use or rely on a digital representation to perform one or more manufacturing operations including, but not limited to, painting, assembling, welding, brazing, seam recognition, path planning, an autonomous welding operation or bonding operations to bond or adhere together separated objects, surfaces, seams, empty gaps, or spaces. To illustrate, a robot, such as a manufacturing robot having one or more electrical or mechanical components, may be configured to accomplish a manufacturing task (e.g., welding), based on the a digital representation, to produce a manufacturing output, such as a welded part. The propagation of the inaccuracies from the digital representation may result in inaccurate or incorrect seam recognition, inaccurate or incorrect path planning, unacceptable welding operations, or wasted time and resources.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure is related to apparatuses, systems, and methods that provide an optical system, including control and operation of the optical system. For example, the present disclosure describes optical systems and methods for rejecting certain reflections when scanning an object. To illustrate, the optical systems may include a reflection refuting laser scanner and/or the methods may use a reflection refuting laser scanner. In some implementations, the optical systems and methods described herein take advantage of the observation that the polarity of first- and second- and other higher-order (e.g., third and above) reflections of the projected laser are different. This difference in polarities may be identified by a controller and therefore further employed by the controller to filter out the superfluous, e.g., second- and higher-order, reflections from the captured images. Filtering out the superfluous reflections (e.g., second-order reflections (and/or other higher-order reflections)) may result in images that predominantly include first-order reflections, which may then be utilized by the controller to more accurately generate a digital representation of the scanned object.

In some implementations, the optical systems and methods provide for or include scanning objects (e.g., metallic objects) using lasers, and capturing one or more images of the object while the object is being laser-scanned. One or more optical parameters (e.g., intensity, polarization filter angle, and the like) associated with the reflections captured in the one or more images may be identified. In some such implementations, the optical systems and methods may rejecting or filter particular type of reflections (second- and/or other higher-order reflections) in accordance with their associated one or more optical parameters and generate a digital representation (e.g., a point cloud) of the object in accordance with the one or more filtered images.

Particular implementations of the subject matter described in this disclosure may be implemented to realize one or more of the following potential advantages or benefits. In some aspects, the present disclosure provides techniques for an optical system. Additionally, or alternatively, as described herein, the present disclosure may provide techniques for using a reflection refuting laser scanner for rejecting certain reflections when scanning an object, such as. The techniques described may enable a system to accurately scan and image a reflective object to allow for accurate generation of a digital representation (e.g., point cloud) of the object. The digital representation may then be relied on for performing additional operations, such as one or more operations associated with welding.

In one aspect of the disclosure, a method, such as a computer-implemented method for an optical system, includes receiving, from a detector, sensor data based on detected light, the detected light including reflections of light projected by one or more emitters and reflected off of an object. The computer-implemented method also includes determining, based on the sensor data, a first-order reflection and a second-order reflection. The computer-implemented method further includes determining, based on the second-order reflection, a difference. The difference includes a polarity difference, an intensity difference, or a combination thereof. The computer-implemented method includes filtering the second-order reflection based on the difference.

In an additional aspect of the disclosure, a system includes a controller configured to receive, from a detector, sensor data based on detected light, the detected light including reflections of light projected by one or more emitters and reflected off of an object. The controller is further configured to determining, based on the sensor data, a first-order reflection and a second-order reflection. The controller is also configured to determine, based on the second-order reflection, a difference. The difference includes a polarity difference, an intensity difference, or a combination thereof. The controller is further configured to filter the second-order reflection based on the difference.

In an additional aspect of the disclosure, a system includes a laser source, a detector, and a controller communicatively coupled to the detector and the laser source. The laser source is configured to project polarized light onto a metallic part. The metallic part is configured to cast multiple reflections following projection of the polarized light. The projected laser light has a first polarity. A first-order reflection from the multiple reflections has a second polarity that is substantially similar to the first polarity. A second-order reflection from the multiple reflections has a third polarity that is substantially different from the first polarity. The detector is configured to detect the first-order reflection based on the second polarity, and the second-order reflection based on the third polarity. The controller is configured to filter the second-order reflection based at least in part on a difference in the second polarity and the third polarity.

In an additional aspect of the disclosure, a method, such as a computer-implemented method for an optical system, includes projecting polarized light onto a metallic part. The metallic part is configured to cast multiple reflections following projection of the polarized light. The projected laser light has a first polarity. A first-order reflection from the multiple reflections has a second polarity that is substantially similar to the first polarity. A second-order reflection from the multiple reflections has a third polarity that is substantially different from the first polarity. The method also includes detecting the first-order reflection based on the second polarity, and the second-order reflection based on the third polarity. The method further includes filtering the second-order reflection based at least in part on a difference in the second polarity and the third polarity.

In an additional aspect of the disclosure, a system includes a first laser unit, a second laser unit, an optical lens, a camera, and a controller. The first laser unit is configured to generate first polarized light having a first polarity. The second laser unit is configured to generate second polarized light having a second polarity. The second polarity is orthogonal to the first polarity. The optical lens is configured to receive the first polarized light and transmit a first laser line at a first location on a metallic object. The first laser line has a polarity that is substantially similar to the first polarity. The optical lens is also configured to receive the second polarized light and transmit a second laser line at the first location on the metallic object. The second laser line has a polarity that is substantially similar to the second polarity. A first-order reflection of the first laser line has a third polarity that is substantially similar to the first polarity. A second-order reflection of the first laser line has a fourth polarity that is substantially different from the first polarity. A first-order reflection of the second laser line has a fifth polarity that is substantially similar to the second polarity. A second-order reflection of the second laser line has a sixth polarity that is substantially different from the second polarity. The camera has an optical filter coupled thereto. The optical filter is configured to pass through more light having the first polarity than the second polarity. The controller is communicatively coupled to the camera. The controller configured to instruct the detector to generate the first polarized light at a first time window and capture a first one or more images of the metallic object during the first time window. The first one or more images captured during the first time window include the first-order reflection of the first laser line having a first intensity and the second-order reflection of the first laser line having a second intensity. The controller is further configured to instruct the detector to generate the second polarized light at a second time window and capture a second one or more images of the metallic object during the second time window. The second one or more images captured during the second first time window includes the first-order reflection of the second laser line having a thief intensity and the second-order reflection of the second laser line having a fourth intensity. The controller is also configured to instruct the detector to identify the second-order reflection of the first laser line and second-order reflection of the second laser line based at least in part on a difference between the second intensity and fourth intensity.

In an additional aspect of the disclosure, a method, such as a computer-implemented method for an optical system, includes generating first polarized light having a first polarity. The method also includes generating second polarized light having a second polarity. The second polarity is orthogonal to the first polarity. The method further includes receiving the first polarized light and transmit a first laser line at a first location on a metallic object. The first laser line has a polarity that is substantially similar to the first polarity. The method includes receiving the second polarized light and transmit a second laser line at the first location on the metallic object. The second laser line has a polarity that is substantially similar to the second polarity. A first-order reflection of the first laser line has a third polarity that is substantially similar to the first polarity. A second-order reflection of the first laser line has a fourth polarity that is substantially different from the first polarity. A first-order reflection of the second laser line has a fifth polarity that is substantially similar to the second polarity. A second-order reflection of the second laser line has a sixth polarity that is substantially different from the second polarity. The method also includes passing through, by an optical filter, more light having the first polarity than the second polarity. The method also includes instructing a detector to generate the first polarized light at a first time window and capture a first one or more images of the metallic object during the first time window. The first one or more images captured during the first time window include the first-order reflection of the first laser line having a first intensity and the second-order reflection of the first laser line having a second intensity. The method also includes instructing the detector to generate the second polarized light at a second time window and capture a second one or more images of the metallic object during the second time window. The second one or more images captured during the second first time window includes the first-order reflection of the second laser line having a thief intensity and the second-order reflection of the second laser line having a fourth intensity. The method further includes instructing the detector to identify the second-order reflection of the first laser line and second-order reflection of the second laser line based at least in part on a difference between the second intensity and fourth intensity.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 is a block diagram illustrating a system configured to implement an optical system according to one or more aspects.

FIG. 2 is a diagram of an example 200 of reflections of polarized light onto an object according to one or more aspects.

FIG. 3 is a diagram of an example internal structure of a detector according to one or more aspects.

FIG. 4 is a diagram of an example of an image that is processed into multiple sub-images according to one or more aspects.

FIG. 5 is a block diagram of an example of an optical system according to one or more aspects.

FIG. 6 is a diagram of an example of a technique to filter one or more second- and/or higher order reflections according to one or more aspects.

FIG. 7 is a block diagram illustrating a system configured to implement an optical system according to one or more aspects.

FIG. 8 is a schematic diagram of a graph-search technique according to one or more aspects.

FIG. 9 is a diagram of a representation of a robotic arm according to one or more aspects.

FIG. 10 is a diagram of an example of a point cloud of parts having a weldable seam according to one or more aspects.

FIG. 11 is a diagram of an example of a point cloud of parts having a weldable seam according to one or more aspects.

FIG. 12 is a block diagram illustrating a registration process flow according to one or more aspects.

FIG. 13 is a block diagram illustrating another system configured to implement an optical system according to one or more aspects.

FIG. 14 is a schematic diagram of an autonomous robotic welding system according to one or more aspects.

FIG. 15 is a flow diagram illustrating an example process to implement an optical system according to one or more aspects.

FIG. 16 is a flow diagram illustrating an example process to implement an optical system according to one or more aspects.

FIG. 17 is a flow diagram illustrating an example process to implement an optical system according to one or more aspects.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support an optical system. For example, the present disclosure relates to optical systems and methods for scanning (e.g., laser scanning) an object, such as a metallic object. To illustrate, an object may be scanned and one or more images of the object may be generated while the object is being scanned. Certain reflections (second- and/or other higher-order reflections) may be rejected or filtered out in accordance with one or more optical parameters (e.g., intensity, polarization filter angle, and the like) associated with the reflections within the one or more images. A digital representation, such as a point cloud, of the object may be generated in accordance with the filtered images.

Although this disclosure describes filtering second-order reflections based on the observation that the polarity of second-order reflection is different from the polarity of first-order reflection, the scope of the present disclosure is not limited to filtration of second-order reflections. The techniques described herein may be applied to filter out any other higher-order (e.g., third-order or higher) reflections. For example, the techniques may filter out a third-order reflections, which may have a polarity that is different (e.g., substantially different) from the polarity of first-order reflection.

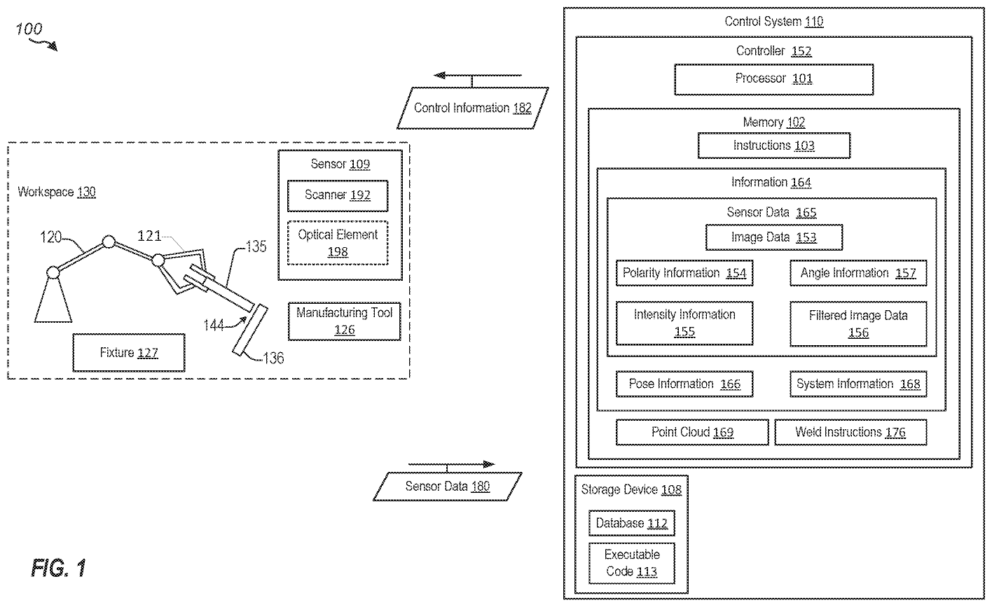

FIG. 1 illustrates a system 100 configured to implement an optical system according to one or more aspects. In some implementations, system 100 includes an autonomous robotic system configured to employ (e.g., utilize) the optical system. For example, system 100 may include a processor-based system, an assembly robot system, or a combination thereof. System 100 of FIG. 1 is configured to enable multipass welding for one or more robots (e.g., manufacturing robots) functioning in a semi-autonomous or autonomous manufacturing environment. In some implementations, system 100 supports or is configured to generating instructions for a welding robot to perform multipass welding operations or a single pass welding operation. a control system 110, a robot 120 (e.g., a manufacturing robot), and a manufacturing workspace 130 (also referred to herein as a “workspace 130”). It is noted that system 100 may include other components or subsystems that are not expressly described herein.

A manufacturing environment or robot, such as a semi-autonomous or autonomous welding environment or a semi-autonomous or autonomous welding robot, may include one or more sensors to scan one or more part, one or more algorithms in the form of software that is configured to recognize a seam to be welded, and one or more algorithms in the form of software to program motion of a robot, the control of an operator, and any other devices such a motorized fixtures, in order to weld the identified seams correctly or as desired without collision. Additionally, or alternatively, the semi-autonomous or autonomous manufacturing environment or robot may also include one or more sensors to scan a part(s), one or more algorithms in the form of software that recognize, localize, or register a given model of the part(s) where the seams are detected using one or more sensors or have already been denoted in some way perhaps in the given model itself, and one or more algorithms in the form of software to program the motion of the robot(s), the control of the operator, and any other devices such a motorized fixtures, in order to weld the seams correctly or as desired without collision. It is noted that a semi-autonomous or autonomous welding robot may have these abilities in part, and where some user given or selected parameters may be required, or user (e.g., operator) involvement may be needed in other ways.

In some implementations, system 100 may include or correspond to an assembly robot system. System 100 may be configured to couple one or more parts, such as a first part 135 (e.g., a first part) and a second part 136 (e.g., a second part). For example, first part 135 and second part 136 may be designed to form a seam 144 between first part 135 and second part 136. Each of first part 135 and second part 136 may be any part, component, subcomponent, combination of parts or components, or the like and without limitation.

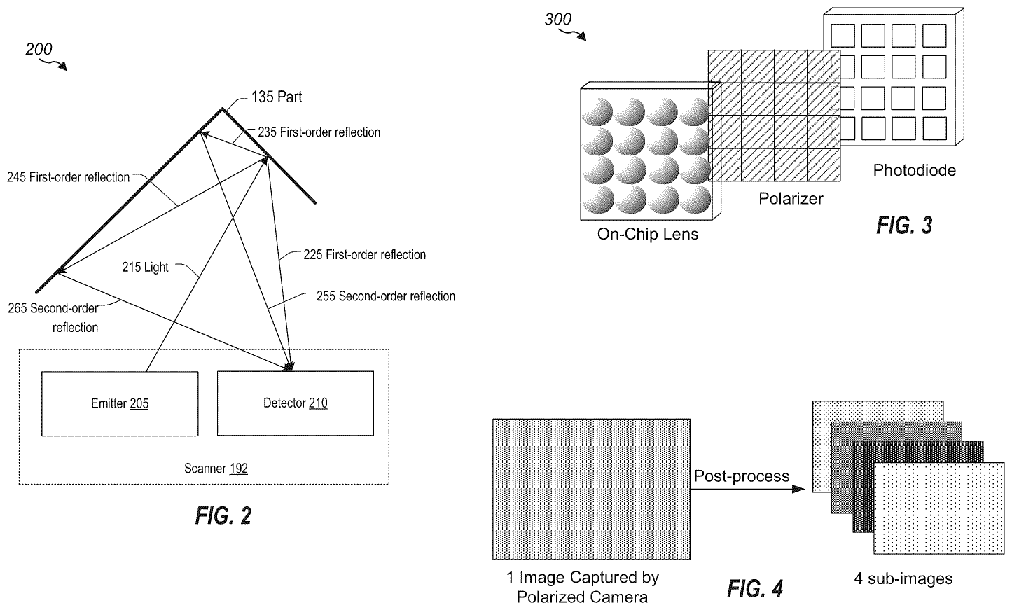

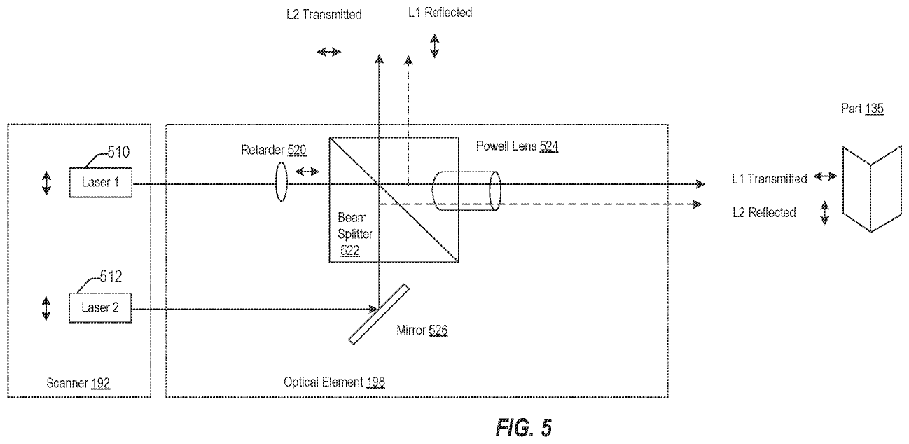

In some implementations, system 100 may include or correspond to an optical system. The optical system may include control system 110 and one or more sensors 109. The one or more sensors may include a scanner 192. Scanner 192 may include one or more emitters, such as one or more light emitters, and a detector, as described further herein at least with reference to FIG. 2. The optical system may optionally include one or more optical elements 198. One or more aspects or components of optical element 198 are described further herein at least with reference to FIG. 3 or 5.

The terms “position” and “orientation” are spelled out as separate entities in the disclosure above. However, the term “position” when used in context of a part means “a particular way in which a part is placed or arranged.” The term “position” when used in context of a seam means “a particular way in which a seam on the part is positioned or oriented.” As such, the position of the part/seam may inherently account for the orientation of the part/seam. As such, “position” can include “orientation.” For example, position can include the relative physical position or direction (e.g., angle) of a part or candidate seam.

Robot 120, also referred to herein as “robot 120”, may be configured to perform a manufacturing operation, such as a welding operation, on one or more parts, such as first part 135 and second part 136. In some implementations, robot 120 can be a robot having multiple degrees of freedom in that it may be a six-axis robot with an arm having an attachment point. Robot 120 may include one or more components, such as a motor, a servo, hydraulics, or a combination thereof, as illustrative, non-limiting examples.

In some implementations, the attachment point may attach a weld head (e.g., a manufacturing tool) to robot 120. Robot 120 may include any suitable tool 121, such as a manufacturing tool. Robot 120 (e.g., a weld head of robot 120) may be configured to move within the workspace 130 according to a path plan and/or weld plan received from control system 110 or a controller 152. Robot 120 is further configured to perform one or more suitable manufacturing processes (e.g., welding operations) on one or more parts (e.g., 135, 136) in accordance with the received instructions, such as control information 182. In some examples, robot 120 can be a six-axis robot with a welding arm. In some implementations, Robot 120 can be any suitable robotic welding equipment, such as YASKAWA® robotic arms, ABB® IRB robots, KUKA® robots, and/or the like Robot 120, in addition to the attached tool 121, can be configured to perform arc welding, resistance welding, spot welding, tungsten inert gas (TIG) welding, metal active gas (MAG) welding, metal inert gas (MIG) welding, laser welding, plasma welding, a combination thereof, and/or the like, as illustrative, non-limiting examples. Robot 120 may be responsible for moving, rotating, translating, feeding, and/or positioning the welding head, sensor(s), part(s), and/or a combination thereof. In some implementations, a welding head can be mounted on, coupled to, or otherwise attached to robot 120.

In some implementations, robot 120 may be coupled to or include one or more tools. For example, based on the functionality the robot performs, the robot arm can be coupled to a tool configured to enable (e.g., perform at least a part of) the functionality. To illustrate, a tool, such as tool 121, may be coupled to an end of robot 120. In some implementations, robot 120 may be coupled to or include multiple tools, such as a manufacturing tool (e.g., a welding tool), a sensor, a picker or holder tool, or a combination thereof. In some implementations, robot 120 may be configured to operate with another device, such as another robot device, as described further herein.

Tool 121 may include one or more tools. For example, tool 121 may include a manufacturing tool (e.g., a welding tool), a sensor (e.g., 109), a picker tool or a holder tool, or a combination thereof. As shown, tool 121 is the picker tool or the holder tool that is configured to be selectively coupled to a first set of one or more objects, such as a first set of one or more objects that include first part 135. In some implementations, the picker tool or the holder tool may include or correspond to a gripper, a clamp, a magnet, or a vacuum, as illustrative, non-limiting examples. For example, tool 121 may include a three-finger gripper, such as one manufactured by OnRobot®.

In some implementations, robot 120, tool 121, or a combination thereof, may be configured to change (e.g., adjust or manipulate) a pose of first part 135 while first part 135 is coupled to tool 121. For example a configuration of robot 120 may be modified to change the pose of first part 135. Additionally, or alternatively, tool 121 may be adjusted (e.g., rotated or tilted) with respect to robot 120 to change the pose of first part 135.

A manufacturing tool 126 may be included in system 100 and configured to perform one or more manufacturing tasks or operations. The one or more manufacturing tasks or operations may include welding, brazing, soldering, riveting, cutting, drilling, or the like, as illustrative, non-limiting examples. In some implementations, manufacturing tool 126 is a welding tool configured to couple two or more objects together. For example, the weld tool may be configured to weld two or more objects together, such as welding first part 135 to the second part 136. To illustrate, the weld tool may be configured to lay a weld metal along a seam formed between first part 135 and second part 136. Additionally, or alternatively, the weld tool may be configured to fuse first part 135 and second part 136 together, such as fusing the seam formed between first part 135 and second part 136 to couple first part 135 and second part 136 together. In some implementations, manufacturing tool 126 may be configured to perform the one or more manufacturing tasks or operations responsive to a manufacturing instruction, such as a weld instruction. Although shown as being separate from robot 120, in other implementations, manufacturing tool 126 may be coupled to robot 120 or to another robot.

Workspace 130 may also be referred to as a manufacturing workspace. Workspace 130 may be or define an area or space, such as an enclosure, within which a robot arm(s), such as robot 120, operates on one or more parts based on or in conjunction with information from one or more sensors. For example, robot 120 may perform one or more operations on parts 135 or 136 that are positioned on, coupled to, or otherwise supported by a platform or positioner while being aided by information received by way of one or more scanners 192. some implementations, workspace 130 can be any suitable welding area designed with appropriate safety measures for welding. For example, workspace 130 can be a welding area located in a workshop, job site, manufacturing plant, fabrication shop, and/or the like. In some implementations, at least a portion of system 100 is positioned with workspace 130. For example, workspace 130 may be an area or space within which one or more robot devices (e.g., a robot arm(s)) is configured to operate on one or more objects (or parts). The one or more objects may be positioned on, coupled to, stored at, or otherwise supported by one or more platforms, containers, bins, racks, holders, or positioners. One or more objects (e.g., 135 or 136) may be held, positioned, and/or manipulated in workspace 130 using fixtures and/or clamps (collectively referred to as “fixtures” or fixture 127). In some examples, workspace 130 may include one or more sensors 109 (hereinafter referred to ss “sensor 109”), fixture 127, and robot 120 that is configured to perform welding-type processes, such as welding, brazing, and bonding on one or more parts to be welded (e.g., a part having a seam 144).

Fixture 127 may be configured to hold, position, and/or manipulate one or more parts (135, 136). In some implementations, fixture 127 may include or correspond to tool 121 or manufacturing tool 126. Fixture may include a clamp, a platform, a positioner, or other types of fixture, as illustrate, non-limiting examples. In some examples, fixture 127 is adjustable, either manually by a user or automatically by a motor. For example, fixture 127 may dynamically adjust its position, orientation, or other physical configuration prior to or during a welding process.

Sensor 109 may include an image sensor, such as a camera, a scanner (e.g., 192), a laser scanner, a camera with in-built laser sensor, or a combination thereof. In some implementations, sensor 109 is an image sensor that is configured to capture visual information (e.g., images) about workspace 130. For example, sensor 109 may be configured to capture images of the one or more parts (135, 136) or fixture 127. In some implementations, sensor 109 may include a Light Detection and Ranging (LiDAR) sensor, an audio sensor, electromagnetic sensor, or a combination thereof. The audio sensor, such as a Sound Navigation and Ranging (SONAR) device, may be configured to emit and/or capture sound. The electromagnetic sensor, such as a Radio Detection and Ranging (RADAR) device, may be configured to emit and/or capture electromagnetic (EM) waves. Through visual, audio, electromagnetic, and/or other sensing technologies, sensor 109 may collect information about physical structures in workspace 130. Additionally, or alternatively, sensor 109 is configured to collect static information (e.g., stationary structures in workspace 130), dynamic information (e.g., moving structures in workspace 130), or a combination thereof.

Sensor 109 may be configured to capture data (e.g., image data) of workspace 130 from various positions and angles. In some implementations, sensor 109 may be mounted onto robot 120 or otherwise be integral to workspace 130. For example, one or more sensors (e.g., 109) may be positioned on robot 120 (e.g., on a weld head of robot 120) and may be configured to collect image data as robot 120 moves about workspace 130. Because robot 120 is mobile with multiple degrees of freedom and therefore in multiple dimensions, the one or more sensors positioned on robot 120 may capture images from a variety of vantage points. Additionally, or alternatively, the one or more sensors may be positioned on an arm (e.g., on a weld head attached to the arm) of robot 120. In another example, sensor 109 may be positioned on a movable, non-welding robot arm (which may be different from robot 120). In yet another example, at least one sensor 109 may be positioned on the arm of robot 120 and another sensor 109 may be positioned on a movable equipment in workspace 130. In yet another example, at least one sensor 109 may be positioned on the arm of robot 120 and another sensors 109 may be positioned on a movable, non-welding robot arm. In some implementations, sensor 109 may be mounted on another robot (not shown in FIG. 1) positioned within workspace 130. For example, a robot may be operable to move (e.g., rotational or translational motion) such that sensor 109 can capture image data of workspace 130, the one or more parts (e.g., 135 or 136), and/or fixture 127 from various angles. In some implementations, sensors 109 may be stationary while physical structures to be imaged are moved about or within workspace 130. For instance, a part (e.g., 135 or 136) to be imaged may be positioned on fixture 127, such as a positioner, and the positioner and/or the part may rotate, translate (e.g., in x-, y-, and/or z-directions), or otherwise move within workspace 130 while a stationary sensor 109 (e.g., either the one coupled to robot 120 or the one decoupled from robot 120) captures multiple images of various facets of the part.

In some implementations, sensor 109 may collect or generate information, such as images or image data, about one or more physical structures in workspace 130. In some instances, sensor 109 may be configured to image or monitor a weld laid by robot 120, before, during, or after weld deposition. Stated another way, the information may include or correspond to a geometric configuration of a seam, the weld laid by robot 120, or a combination thereof. The geometric configuration may include 3D point cloud information, mesh, image of a slice of the weld, point cloud of the slice of the weld, or a combination thereof, as illustrative, non-limiting examples. Sensor 109 may provide the information to another component or device, such as control system 110, controller 152, or processor 101. The other component or device may generate a 3D representation, such as a point cloud (e.g., 169), of one or more physical structures in workspace 130 based on the information (e.g., image data).

Sensor 109 can be communicatively coupled to another device, such as processor 101, controller 152, or control system 110, which can be operable to process data from sensor 109 to assemble two-dimensional data, data from sensor 109 at various positions relative to the one or more parts, or data from sensor 109 as the sensors move relative to the parts for further processing. Control system 110, such as controller 152 or processor 101, can generate the point cloud (e.g., 169) by overlapping and/or stitching images to reconstruct and generate three-dimensional image data. The three-dimensional image data can be collated to generate the point cloud with associated image data for at least some points in the point cloud. Control system 110 may be configured to operate and control robot 120. In some instances, control parameters for robot 120 can be determined or informed by data from the point cloud.

In some implementations, sensor 109 includes one or more scanners 192 (hereinafter referred to as “scanner 192”). Scanner 192 may be configured to capture information about workspace 130. In some examples, scanner 192 includes one or more image sensors that are configured to capture visual information (e.g., two-dimensional (2D) images) about workspace 130. For instance, scanner 192 may include a laser (e.g., a laser scanner), a camera, or a combination thereof (e.g., cameras with built-in lasers). In some implementations, scanner 192 is configured to collect static information (e.g., stationary structures in workspace 130), dynamic information (e.g., moving structures in workspace 130), or a combination of static and dynamic information. Scanner 192 may be configured to collect any suitable combination of any and all such information about the physical structures in workspace 130 and may provide such information to other components (e.g., controller 152) to generate a 3D representation of the physical structures in workspace 130. The information may be provided to controller 152 as sensor data 180 or 165, image data 153, polarity information 154, intensity information 155, angle information 157, filtered image data 156, point cloud 169, or a combination thereof. In some implementations, scanner 192 may capture and communicate any of a variety of information types. For example, scanner 192 may be configured to capture visual information (e.g., 2D images) of workspace 130, which are subsequently used en masse to generate 3D representations of workspace 130 as described further herein.

Although shown as a single entity which may include or be enclosed in a single housing, scanner 192 may include two separate entities positioned in separate housings. For example, scanner 192 may include an emitter, such as a laser projection entity, positioned in a first housing and a detector, such as a camera entity, positioned in a second housing. The emitter and the detector are described further herein at least with reference to FIGS. 2 and 5. In such examples, the emitter and the detector may be configured to independently perform their respective functionalities (e.g., projecting light and capturing image data or an image, respectively). Additionally, or alternatively, the emitter and the detector may be configured to independently communicate with each other and/or with controller 152. In some implementations, the emitter may be configured to project a laser onto part 135, while the detected is configured to capture one or more images of part 135 when part 135 is illuminated by light form the emitter. In some such implementations, the functionalities of the emitter and the detector may be controlled and/or time-coordinated by controller 152. In some implementations, the detector, such as a camera, may be configured to detect the order of the reflection (e.g., first-order/second-order/higher-order) of an incident laser light (e.g., polarized light) based on the polarity of the detected light. For example, as described further herein at least with reference to FIGS. 3 and 4, the detector may include a directional polarizer having one or more unique features which allow the detector to capture multiple polarization images (e.g., sub-images) in one image (e.g., one shot).

To generate digital or 3D representations of workspace 130, scanner 192 may capture 2D images of physical structures in workspace 130 from one or more angles. To illustrate, a single 2D image of a fixture 127 or part 135 may be inadequate to generate a digital or 3D representation of that component, and, similarly, a set of multiple 2D images of fixture 127 or part 135 from a single angle, view, or plane may be inadequate to generate a 3D representation of that component. However, multiple 2D images captured from multiple angles in a variety of positions within workspace 130 may be adequate to generate (e.g., using stereo image processing) a 3D representation of a component, such as fixture 127 or part 135. This is because capturing 2D images in multiple orientations provides spatial information about a component in three dimensions, similar in concept to the manner in which plan drawings of a component that include frontal, profile, and top-down views of the component provide all information necessary to generate a 3D representation of that component. Accordingly, scanner 192 may be configured to move about workspace 130 so as to capture information adequate to generate 3D representations of structures within workspace 130. Additionally, or alternatively, scanner 192 may be stationary but multiple scanners may be present in adequate numbers and in adequately varied locations around workspace 130 such that adequate information is captured by the scanners (e.g., 192) to generate the aforementioned 3D representations. In implementations where scanner 192 is mobile, any suitable structures may be useful to facilitate such movement about workspace 130. For example, one or more scanners 192 may be positioned on a motorized track system. The track system itself may be stationary while scanner 192 is configured to move about workspace 130 on the track system. Additionally, or alternatively, in some other implementations, scanner 192 is mobile on the track system and the track system itself is mobile around workspace 130. Additionally, or alternatively, in still other implementations, one or more mirrors are arranged within workspace 130 in conjunction with scanner 192 that may pivot, swivel, rotate, or translate about and/or along points or axes such that scanner 192 capture 2D images from initial vantage points when in a first configuration and, when in a second configuration, capture 2D images from other vantage points using the mirrors. Additionally, or alternatively, scanner 192 may be suspended on arms that may be configured to pivot, swivel, rotate, or translate about and/or along points or axes, and scanner 192 may be configured to capture 2D images from a variety of vantage points as these arms extend through their full ranges of motion. Examples of placement of scanner 192 (e.g., sensor 109) are described further herein at least with reference to FIG. 7.

Controller 152 may be configured to control scanner 192, robot 120, fixture 127, or a combination thereof, within workspace 130. For example, controller 152 may be configured to control scanners 192 to move within workspace 130 and/or to capture 2D images, as described herein. Additionally, or alternatively, controller 152 may be configured to control robot 120 to perform welding operations and to move within workspace 130 according to a path planning technique as described herein. Additionally, or alternatively, controller 152 may be configured to manipulate fixture 127, such as a positioner (e.g., platform, clamps, etc.), to rotate, translate, or otherwise move one or more parts within workspace 130.

Referring to FIG. 2, FIG. 2 is a diagram of an example 200 of reflections of polarized light onto an object (e.g., part 135 or 136) according to one or more aspects. Example 200 includes scanner 192 and part 135. In some implementations, example 200 may include or show a portion or an entirety of an optical system. For example, the optical system may include scanner 192. In some implementations, the optical system may also include optical element 198, a controller, such as control system 110 or controller 152, or a combination thereof.

Part 135 may be a curved metallic object. In some implementations, part 135 is a complex, curved, and/or reflective object. As shown, part 135 is L-shaped. Although shown or described as a single part with reference to FIG. 2, in other implementations, part 135 may include multiple parts or objects that are in a coupled or uncoupled state. For example, multiple parts or objects may be in the uncoupled state and be positioned in a spatial relationship with respect to each other.

Scanner 192 includes one or more emitters 205 (hereinafter referred to as “emitter 205”) and one or more detectors 210 (hereinafter referred to as “detector 210”). Although described as being separate, in some implementations, emitter 205 and detector 210 may be or may be include in the same device.

Emitter 205 may be configured to emit or project light 215. For example, emitter 205 may include a laser (also referred to as a laser source or laser unit) or other light source. Emitter 205 may be configured to generate polarized light 215. Additionally, or alternatively, emitter 205 may be configured to transmit polarized light 215 onto part 315. In some implementations, part 315 may be illuminated with polarized light 215 from emitter 205. Although described as a single emitter 205, in other implementations, scanner 192 may include multiple emitters (e.g., 205), such as multiple lasers, as described further herein at least with reference to FIG. 5.

Detector 210 may be configured to detect light 215, reflected light, or a combination thereof. Detector 210 may include or be an image capture device, such as a camera. Detector 210 is configured to capture one or more images of part 135. For example, detector 210 may capture an image of part 135 while light 215 is transmitted by emitter 205—e.g., while part 135 is illuminated by emitter 205. The reflected light may include a reflection of light 215, such as a first-order reflection, a second-order reflection, a third-order reflection, or another higher-order reflection. For example, the reflections detected by detector 210 may include a first-order reflection and a second-order reflection that results from a projection of the polarized light onto part 135, such as a curved part.

Referring to FIG. 3, FIG. 3 is a diagram of an example 300 of an internal structure of a detector (e.g., 210) according to one or more aspects. Detector 210 may be configured to capture one or more images, such as multiple polarization images in one image (one shot)—e.g., multiple polarization sub-images of or included in one image. An example of one or more images captured by detector 210 is described further herein at least with reference to FIG. 4.

The structure of detector 210 may include an on-chip lens, a polarizer filter, and a photodiode. The on-chip lens may be configured to guide arriving light, such as all arriving light, to the detector's photodiode via a polarizer. In some implementations, the on-chip lens, the polarizer filter, the photodiode, or a combination thereof, include or correspond to optical element 198.

It is noted that light, such as light 215, has physical elements, such as brightness (amplitude), color (wavelength), and polarization (vibrational direction). As an example, light from the Sun or fluorescent lamps vibrate in various directions and are therefore referred to as unpolarized light.

A polarizer is generally used to eliminate certain vibrational directions, such that when unpolarized light passes through the polarizer, it emerges as polarized light having vibrational direction only in one direction. The same principle may be used or applied to one or more implementations described herein, such as one or more implementations of detector 210—e.g., a camera. In some implementations, the polarizer (such as the polarizer shown in FIG. 3) may include different wire-grid patterns such that each one of the different wire-grid patterns allows one kind of vibrational direction—such as a vibrational direction perpendicular to the angle of incidence of the incoming light—to pass through them. As an illustrative, non-limiting example, the polarizer may include 4 wire-grid patterns. The 4 wire-grid patterns may include a first wire-grid pattern, a second wire-grid pattern, a third wire-grid pattern, and a fourth wire-grid pattern. The first wire grid pattern may be configured to pass through light having a vibrational direction similar (e.g., within a margin of error of +/−0-2 degrees) to the angle of incidence of the incoming light. The second wire-grid pattern may be configured to pass through light having a vibrational direction at about 45 degrees (+/−2 degrees) to the angle of incidence of the incoming light. The third wire-grid pattern may be configured to pass through light having a vibrational direction at about 90 degrees (+/−2 degrees) to the angle of incidence of the incoming light. The fourth wire-grid pattern may be configured to pass through light having a vibrational direction at about 135 degrees (+/−2 degrees) to the angle of incidence of the incoming light. Simply put, the use of a polarizer having different wire-grid patterns allows the detection of lights having different vibrational directions or polarities. Although described as having a 4 wire-grid pattern, other configurations of the polarizer may be used.

The structure of detector 210 may be configured to detect light(s) having different vibrational directions or polarities which may allow for detector 210 to capture polarization data (e.g., polarity) of multiple different lights. For example, the polarization data, such as sensor data 180 or 165, image data 153, or polarity information 154, may be captured by detector 210 in one shot. Stated another way, the one shot includes data related to polarities of incoming light. Data, such as the polarization data, captured by detector 210 may be extracted by controller 152 (or another device) that performs a post processing technique and/or by using a neural network configured for such extraction. For example, the post processing technique may include a polynomial. Accordingly, the capturing of polarization data of different lights in one shot may be referred to herein as capturing multiple polarization images in one shot.

Referring to FIG. 4, FIG. 4 is a diagram of an example of an image that is processed into multiple sub-images according to one or more aspects. For example, one image (or shot) may be captured by detector 210 (e.g., a camera). The one image may include or correspond to image data, such as sensor data 180 or 165 or image data 153. The one image may be processed into multiple sub-images, such as 4 sub-images. In some implementations, each sub-image may correspond to a wire-grid pattern of the polarizer, such as the polarizer as described with reference to FIG. 3, and may have or includes polarity information of the captured light. The polarity information may include or correspond to polarity information 154. It is noted that in some implementations, the number of sub-images may depend on the number of different wire-grid patterns in detector 210. For example, for a detector having 2 different wire-grid patterns, one image (e.g., one shot) may be processed into two sub-images, with each sub-image capturing polarity information of the captured light.

Referring back to FIG. 2, during operation, emitter 205 transmits light 215 that strikes part 135. Light 215 may be diffused into one or ore first-order reflections. For example, light 215 that strikes part 135 may diffuse into multiple different first-order reflections, such as representative first-order reflections 225, 235, and 245. A first-order reflection may experience an additional reflection at a different location on part 135 (or another part). The additional reflection of the first-order reflection may result in one or more second-order reflections. To illustrate, first-order reflection 235 and 245 may experience additional reflections at different locations on part 135 and the additional reflections of first-order reflections 235 and 245 may result in second-order reflections 255 and 265, respectively. As an illustrative example, first-order reflection 225 and second-order reflections 255 and 265 may be captured or detected by detector 210. For example, first-order reflection 225 and second-order reflections 255 and 265 may be captured or detected by detector 210 one or more images. To illustrate, detector 210 may generate image data (e.g., sensor data 180 or 165, or image data 153) based on received first-order reflection 225, second-order reflection 255, second-order reflection 265, or a combination thereof.

It is noted that generation of a 3D representation (e.g., point cloud 169) of part 135 may be generated based on the image data generated by detector 210, as described further herein. An accuracy of the 3D representation may be improved if the second-order reflections (and/or other higher-order reflections) are filtered out. Accordingly, the optical systems and methods described herein are includes techniques for rejecting/filtering out second- and/or other higher-order reflections in accordance with one or more optical parameters. Rejecting and/or filtering out second- and/or other higher-order reflections may assists in generating an accurate digital representation of part 135 being imaged.

Referring back to FIG. 1, in some implementations, sensor 109 may include one or more optical elements 198 (hereinafter referred to as “optical element 198”). Optical element 198 may include a filter, a lens, a Powell lens, a retarder, a polarizer, a photodiode, a beam splitter, a mirror, or a combination thereof, as illustrative, non-limiting examples. Although optical element 198 is shown as being included in sensor 109 and separate from scanner 192, in other implementations, optical element 198 may be separate from or coupled to sensor 109, or may be included in scanner 192. In some implementations, optical element 198 may be referred to as an optical instrument, which may include one or more optical elements. Optical elements are optional. Scanner includes light emitter and detector. Light emitter includes a laser (e.g., a laser source) and detector may include a camera.

Referring now to FIG. 5, FIG. 5 is a block diagram of an example of an optical system according to one or more aspects. As shown, the optical system includes scanner 192 and optical element 198. The optical system is configured to scan part 135. In some implementations, the optical system may also include a detector, such as detector 210, controller 152, or a combination thereof. For example, the optical system may also include detector 210 and the optical system may be configured to be coupled to controller 152 but may or may not include controller 152. Detector 210 may include a camera, such as a camera that includes or is coupled to a polarization filter (e.g., a polarization filter as described herein at least with reference to FIG. 3.

As shown in FIG. 5, scanner 192 includes multiple emitters, such as a first laser 510 (Laser 1) and a second laser 512 (Laser 2). The vertical and horizontal arrows shown in FIG. 5—for example the arrows near the blocks representing first laser 510 and second laser 512—indicate a polarity associated with that respective device. For example, the arrows corresponding to first laser 510 and second laser 512 indicate the polarities of the lasers projected by first laser 510 and second laser 512, respectively. Similarly, the arrows corresponding to the laser lines (notated as L1 transmitted and L2 reflected) incident onto part 135 indicate the polarities of the projected laser lines, respectively. It is noted that the arrows corresponding to the laser being split (notated as L2 transmitted and L1 reflected) indicates the polarities of the filtered laser.

As shown in FIG. 5, optical element 198 includes a retarder 520, a beam splitter 52, a mirror 526, and a Powell lens 524. Retarder 520 is configured to alter (e.g., change) a polarity of an incoming laser that is received by retarder 520. With respect to the optical system shown in FIG. 5, retarder 520 is arranged with the optical system because first laser 510 and second laser 512 have the same polarities and, for an optical system that is associated with or utilizes a double laser technique as described herein, the polarities of the two lasers incident to part 135 should be or need to substantially or approximately orthogonal (e.g., 90 degrees out of phase) to each other. It is noted that use of retarder 520 may be avoided or omitted in a configuration of the optical system where because first laser 510 and second laser 512 have orthogonal polarities. In other words, because first laser 510 and second laser 512, in the example configuration shown in FIG. 5, have the same polarity, however in other configurations, because first laser 510 and second laser 512 may have orthogonal polarities. In such configurations in which first laser 510 and second laser 512 may have orthogonal polarities, the use of some of one or more components, such as retarder 520, of optical element 198 may be avoided.

Mirror 526 and beam splitter 522 may be configured to direct light from both of first laser 510 and second laser 512 to a location, such as the same location, on part 135. Powell lens 524 may be configured to receive a laser (e.g., laser light) and transform the received laser into a line (e.g., a laser line) that is output by Powell lens 524. Although the optical system of FIG. 5 is described as including retarder 520, beam splitter 52, mirror 526, and Powell lens 524, in other implementations of the optical system, the optical system may not include one or more of retarder 520, beam splitter 522, mirror 526, or Powell lens 524, and/or may include one or more additional optical elements 198.

During operation of the optical system of FIG. 5, at a first time t1, a laser from first laser 510 may be projected onto part 135 via retarder 520, beam splitter 522, and Powell lens 524. Retarder 520 alters the initial polarity of first laser 510 in that the laser departing retarder 520 has a polarity that is orthogonal (e.g., substantially or approximately orthogonal) to the incoming laser. The laser departing retarder 520 may further be split in two by beam splitter 522—the split lasers are notated as L1 transmitted and L1 reflected. The L1 transmitted portion has the polarity similar to the polarity of first laser 510 departing from retarder 520, whereas the L1 reflected portion has the polarity similar to the initial polarity of first laser 510. The L1 transmitted portion of the laser may then be transformed into a line by Powell lens 524 and strike part 135 at a first location.

At a second time t2, a laser from second laser 512 may be projected onto part 135 via mirror 526, beam splitter 522, and Powell lens 524. The second time t2 may be a different time from first time t1. Mirror 526 may be used in some examples in case the scanner 102 has space constraints. If space constraints do not exist, the use of mirror 526 may be avoided. The laser departing mirror 526 may be split in two by beam splitter 522; the split lasers are notated as L2 transmitted and L2 reflected. The L2 reflected portion has the polarity similar to the initial polarity of second laser 512, whereas the L2 transmitted portion has the polarity orthogonal to the initial polarity of laser 2. The L2 reflected portion of the laser may then be transformed into a line by Powell lens 524 and strike part 135 at the first location.

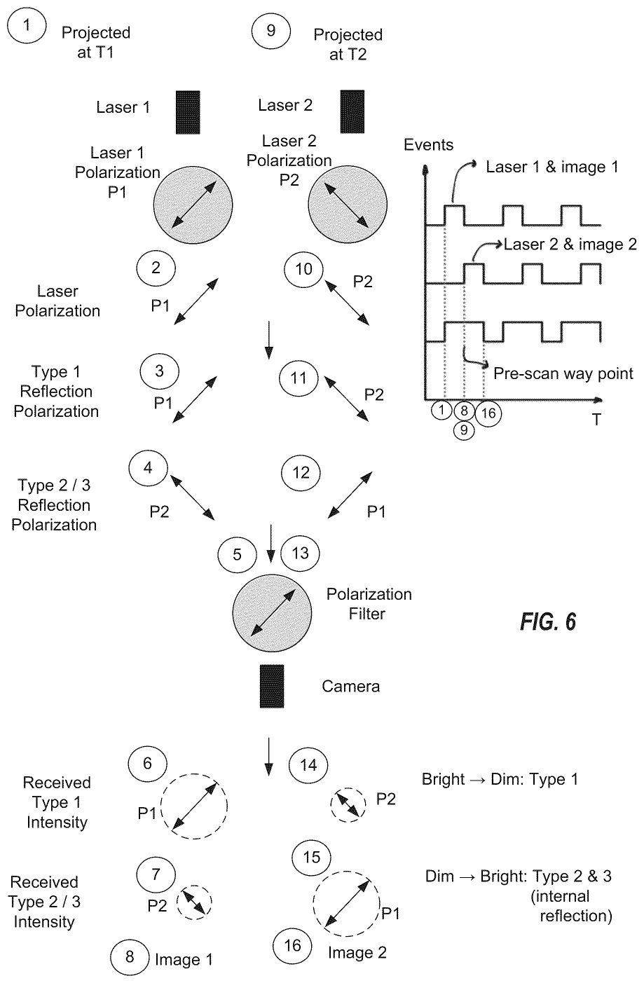

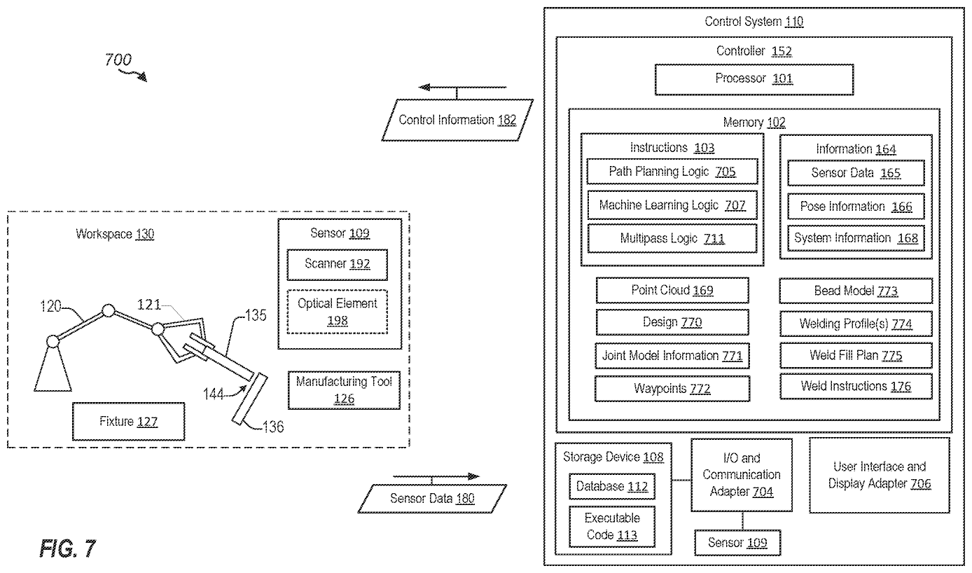

In some implementations, a polarization filter coupled to detector 210 may have a polarity similar to the initial polarity of first laser 510. Detector 210 may capture a first image at time t1 and a second image at time t2. As described further herein at least with reference to FIG. 6, during application or implementation of the double laser technique, controller 152 may use a difference in intensities (e.g., 155) between the second-order reflections associated with the laser from first laser 510 and the second-order reflections associated with the laser from second laser 512 to filter the second-order reflections. For example, controller 152 may filter the second-order reflections from either of the two images—e.g., the first image or the second image. The image having been filtered predominantly includes first-order reflections and therefore could be used to generate an accurate 3D representation, such as point cloud 169, of part 135.

Referring back to FIG. 1, control system 110 is configured to operate and control a robot 120 to perform manufacturing functions in workspace 130. For instance, control system 110 can operate and/or control robot 120 (e.g., a welding robot) to perform welding operations on one or more parts. Although described herein with reference to a welding environment, the manufacturing environment may include one or more of any of a variety of environments, such as assembling, painting, packaging, and/or the like. In some implementations, workspace 130 may include one or more parts (e.g., 135 or 136) to be welded. The one or more parts may be formed of one or more different parts. For example, the one or more parts may include a first part (e.g., 135) and a second part (e.g., 136), and the first and second parts form a seam (e.g., 144) at their interface. In some implementations, the first and second parts may be held together using tack welds. In other implementations, the first and second parts may not be welded and robot 120 just performs tack welding on the seam of the first and second parts so as to lightly bond the parts together. Additionally, or alternatively, following the formation of the tack welds, robot 120 may weld additional portions of the seam to tightly bond the parts together. In some implementations, robot 120 may perform a multipass welding operation to lay weld material in seam 144 to form a joint.

In some implementations, control system 110 may be implemented externally with respect to robot 120. For example, control system 110 may include a server system, a personal computer system, a notebook computer system, a tablet system, or a smartphone system, to provide control of robot 120, such as a semi-autonomous or autonomous welding robot. Although control system 110 is shown as being separate from robot 120, a portion or an entirety of control system 110 may be implemented internally to robot 120. For example, the portion of control system 110 internal to robot 120 may be as included as a robot control unit, an electronic control unit, or an on-board computer, and may be configured to provide control of robot 120, such as a semi-autonomous or autonomous welding robot.

Control system 110 implemented internally or externally with respect to robot 120 may collectively be referred to herein as “robot controller 110”. Robot controllers 110 may be included in or be coupled to a seam identification system, a trajectory planning system, a weld simulation system, another system relevant to the semi-autonomous or autonomous welding robots, or a combination thereof. It is noted that one or more a seam identification system, a trajectory planning system, a weld simulation system, or another system relevant to the semi-autonomous or autonomous welding robots may be implemented independently or externally of control system 110.

Control system 110 may include one or more components. For example, control system 110 may include a controller 152 and a storage device 108. The controller 152 may include a processor 101 and a memory 102. Although processor 101 and memory 102 are both described as being included in controller 152, in other implementations, processor 101, memory 102, or both may be external to controller 152, such that each of processor 101 or memory 102 may be one or more separate components. In some implementations, controller 152 may include one or more additional components as described further herein at least with reference to FIG. 7. Storage device 108 may include one or more memories, such as memory 102. Although storage device 108 is shown and described as being included in system 100, in other implementations, storage device 108 may be external or remote from control system 110 or controller 152. Control system 110 or controller 152 may access storage device 108 via a bus or a network.

Controller 152 may be any suitable machine that is specifically and specially configured (e.g., programmed) to perform one or more operations attributed herein to controller 152, or, more generally, to system 100. In some implementations, controller 152 is not a general-purpose computer and is specially programmed or hardware-configured to perform the one or more operations attributed herein to controller 152, or, more generally, to system 100. Additionally, or alternatively, the controller 308 is or includes an application-specific integrated circuit (ASIC), a central processing unit (CPU), a field programmable gate array (FPGA), or a combination thereof. In some implementations, controller 152 includes a memory, such as memory 102, storing executable code, which, when executed by controller 152, causes controller 152 to perform one or more of the actions attributed herein to controller 152, or, more generally, to system 100. Controller 152 is not limited to the specific examples described herein.

In some implementations, controller 152 is configured to control sensor(s) 109, such as scanner 192, and robot 120 within workspace 130. Additionally, or alternatively, controller 152 is configured to control fixture(s) 127 within workspace 130. For example, controller 152 may control robot 120 to perform welding operations and to move within workspace 130 according to a path planning and/or weld planning techniques. Controller 152 may also manipulate fixture(s) 127, such as a positioner (e.g., platform, clamps, etc.), to rotate, translate, or otherwise move one or more parts within workspace 130. Additionally, or alternatively, controller 152 may control sensor(s) 109 to move within workspace 130 and/or to capture images (e.g., 2D or 3D), audio data, and/or EM data.

In some implementations, control system 110 may include a bus (not shown). The bus may be configured to couple, electrically or communicatively, one or more components of control system 110. For example, the bus may couple processor 101 and memory 102.

Processor 101 may include a central processing unit (CPU), which may also be referred to herein as a processing unit. Processor 101 may include a general purpose CPU, such as a processor from the CORE family of processors available from Intel Corporation, a processor from the ATHLON family of processors available from Advanced Micro Devices, Inc., a processor from the POWERPC family of processors available from the AIM Alliance, etc. However, the present disclosure is not restricted by the architecture of processor 101 as long as processor 101 supports one or more operations as described herein. For example, processor 101 may include one or more special purpose processors, such as an application specific integrated circuit (ASIC), a graphics processing unit (GPU), a field programmable gate array (FPGA), etc.

Memory 102 may include a storage device, such as random access memory (RAM) (e.g., SRAM, DRAM, SDRAM, etc.), ROM (e.g., PROM, EPROM, EEPROM, etc.), one or more HDDs, flash memory devices, SSDs, other devices configured to store data in a persistent or non-persistent state, or a combination of different memory devices. Memory 102 is configured to store user and system data and programs, such as may include some or all of the aforementioned program code for performing functions of the machine learning logic-based adjustment techniques and data associated therewith.

Memory 102 includes or is configured to store instructions 103 and information 164. Memory 102 may also store other information or data, such as a point cloud 169, and weld instructions 176. In one or more aspects, memory 102 may store the instructions 103, such as executable code, that, when executed by the processor 101, cause processor 101 to perform operations according to one or more aspects of the present disclosure, as described herein. In some implementations, instructions 103 (e.g., the executable code) is a single, self-contained, program. In other implementations, the instructions (e.g., the executable code) is a program having one or more function calls to other executable code which may be stored in storage or elsewhere. The one or more functions attributed to execution of the executable code may be implemented by hardware. For example, multiple processors may be used to perform one or more discrete tasks of the executable code.

Information 164 may include or indicate sensor data 165. Sensor data 165 may include or correspond to the sensor data 180 received by controller 152. Image data 153 may include or be associated with one or more images. In some implementations, the one or more images may include one or more sub-images of an image. Polarity information 154 may include or indicate a polarity of a light or laser. Additionally, or alternatively, polarity information 154 may include or indicate a polarity difference. Intensity Information 155 may include or indicate a polarity of a light or laser. Additionally, or alternatively, intensity information 155 may include or indicate an intensity difference. Angle information 157 may include or indicate an angle associated with a light or laser. Additionally, or alternatively, angle information 157 may include or indicate an angle of linear polarization difference. Filtered image data 156 may include a version of image data 153 that has been filtered based on a difference, such as a polarity difference, an intensity difference, an angle of linear polarization difference, or a combination thereof.

Point Cloud 169 may include a set of points each of which represents a location in 3D space of a point on a surface of an object, such as a part (e.g., 135 or 136) and/or fixture 127. Examples of points are described further herein at least with reference to FIGS. 10 and 11.

Referring to FIG. 10, FIG. 10 is an illustrative point cloud 1000 of parts having a weldable seam according to one or more aspects. Point cloud 1000 represents a first part 1002 and a second part 1004. First part 1002 and second part 1004 may include or correspond to first part 135 and second part 136, respectively. First part 1002 and second part 1004 may be positioned to define a seam 1006. Seam 1006 may include or correspond to seam 144. First part 1002 and second part 1004 may be configured to be welded together along seam 1006. In some implementations, first part 1002 and second part 1004 may be welded together based on a multipass welding operation performed by robot 120.

Referring to FIG. 11, FIG. 11 is an illustrative point cloud 1100 of parts having a weldable seam according to one or more aspects. Point cloud 1100 represents a first part 1102 and a second part 1104. First part 1102 and second part 1104 may include or correspond to first part 135 and second part 136, respectively. First part 1102 and second part 1104 may be positioned to define a seam 1106. Seam 1106 may include or correspond to seam 144. First part 1102 and second part 1104 may be configured to be welded together along seam 1106. In some implementations, first part 1102 and second part 1104 may be welded together based on a multipass welding operation performed by robot 120.

Referring back to FIG. 1, controller 152 configured may be configured to generate the 3D point cloud 1000 or 1100 based on images captured by sensor 109. Controller 152 may then use the point cloud 1000 or 1100, image data, or a combination thereof, to identify and locate a seam, such as the seam 1006 or 1106, to plan a welding path along the seam 1006 or 1106, and to lay a weld material along seam 1006 or 1106 according to the path plan and using robot 120. In some implementations, controller 152 may execute instructions 103 (such as path planning logic 705, machine learning logic 707, or multipass logic 711 as described further herein at last with reference to FIG. 7), executable code 113, or a combination thereof, to perform one or more operations, such as seam identification, path planning, model training or updating, or a combination thereof. In some implementations, controller 152 may be configured to use a neural network to perform a pixel-wise classification and/or point-wise classification to identify and classify structures within workspace 130.

In some implementations, controller 152 is configured to receive information, such as images or image data, audio data, EM data, or a combination thereof, from sensor 109 or scanner 192. Controller 152 may generate a 3D representation, such as point cloud 169, of one or more structures associated with the received information. For example, the one or more structures may be depicted in the images. In some examples, one or more images (e.g., image data captured by sensor 109 at a particular orientation relative to a part) may be overlapped and/or stitched together by controller 152 to reconstruct and generate 3D image data of workspace 130. The 3D image data can be collated to generate the point cloud with associated image data for at least some points in the point cloud.

In some implementations, the 3D image data can be collated by controller 152 in a manner such that the point cloud generated from the data can have six degrees of freedom. For instance, each point in the point cloud may represent an infinitesimally small position in 3D space. As described above, sensor 109 can capture multiple images of the point from various angles. These multiple images can be collated by controller 152 to determine an average image pixel for each point. The averaged image pixel can be attached to the point. For example, if sensor 109 is a color camera having red, green, and blue channels, then the six degrees of freedom can be {x-position, y-position, z-position, red-intensity, green-intensity, and blue-intensity}. Alternatively, if sensor 109 is a black and white camera with black and white channels, then four degrees of freedom may be generated.

In some implementations, to generate 3D representations of workspace 130, sensor 109 may capture images of physical structures in workspace 130 from a variety of angles. For example, although a single 2D image of fixture 127 or a part (e.g., 135 or 136) may be inadequate to generate a 3D representation of that component, and, similarly, a set of multiple images of fixture 127 or the part from a single angle, view, or plane may be inadequate to generate a 3D representation of that component, multiple images captured from multiple angles in a variety of positions within workspace 130 may be adequate to generate a 3D representation of a component, such as fixture 127 or a part. This is because capturing images in multiple orientations provides spatial information about a component in three dimensions, similar in concept to the manner in which plan drawings of a component that include frontal, profile, and top-down views of the component provide all information necessary to generate a 3D representation of that component. Accordingly, in examples, sensor 109 is configured to move about workspace 130 so as to capture information adequate to generate 3D representations of structures within workspace 130.

In some implementations, multiple sensors (e.g., 109) are stationary but are present in adequate numbers and in adequately varied locations around workspace 130 such that adequate information is captured by the sensors to generate the aforementioned 3D representations. In examples where sensor 109 is mobile, any suitable structure may be useful to facilitate such movement about workspace 130. For example, sensor 109 may be positioned on a motorized track system. The track system itself may be stationary while sensor 109 is configured to move about workspace 130 on the track system. In some other implementations, sensor 190 is mobile on the track system and the track system itself is mobile around workspace 130. In other implementations, one or more mirrors are arranged within workspace 130 in conjunction with sensor 109, which may pivot, swivel, rotate, or translate about and/or along points or axes such that sensor 109 is configured to capture images from initial vantage points when in a first configuration and, when in a second configuration, capture images from other vantage points using the mirrors. In yet other implementations, sensor 109 may be suspended on arms that may be configured to pivot, swivel, rotate, or translate about and/or along points or axes, and sensor 109 may be configured to capture images from a variety of vantage points as these arms extend through their full ranges of motion.

Weld instructions 176 may include or indicate one or more operations to be performed by robot 120. Weld instructions 176 may be generated based on one or more weld profiles, a weld fill plan, or a combination thereof. Generation of weld instruction 176 is described further herein at least with reference to FIG. 7.

In some implementations, storage device 108 includes a database 112 and executable code 113. Controller 152 may interact with database 112, for example, by storing data to database 112 and/or retrieving data from database 112. Although described as database 112 being in storage device 108, in other implementations, database 112 may more generally be stored in any suitable type of storage device 108 that is configured to store any and all types of information. In some examples, the database 112 can be stored in storage device 108 such as a random access memory (RAM), a memory buffer, a hard drive, an erasable programmable read-only memory (EPROM), an electrically erasable read-only memory (EEPROM), a read-only memory (ROM), Flash memory, and the like. In some examples, the database 112 may be stored on a cloud-based platform.

Database 112 may store any information useful to the system 100 in performing welding operations. For example, the database 112 may store one or more images captured by the scanner 192 to generate digital representation of part 135. Further, database 112 may store a CAD model (e.g., 770) of one or more parts (e.g., 135, 136). Additionally, or alternatively, database 112 may store an annotated version of a CAD model of one or more parts (e.g., 135, 136). Database 112 may also store a point cloud of the one or more parts generated using the CAD model (also herein referred to as CAD model point cloud). Similarly, welding instructions (e.g., 176) for one or more parts that are generated based on 3D representations of the one or more parts and/or on user input provided regarding one or more parts (e.g., regarding which seams of the part (e.g., 135 or 136) to weld, welding parameters, etc.) may be stored in database 112.

In some implementations, executable code 113 may when executed, causes controller 152 to perform one or more actions attributed herein to controller 152, or, more generally, to the system 100. Executable code 113 may include a single, self-contained, program. Additionally, or alternatively executable code 113 may be a program having one or more function calls to other executable code which may be stored in storage device 108 or elsewhere, such as cloud storage or memory 102, as illustrative, non-limiting examples. In some examples, one or more functions attributed to execution of executable code 113 may be implemented by hardware. For instance, multiple processors may be useful to perform one or more discrete tasks of the executable code 113.

In some implementations, system 100 may include sensor 109, such as scanner 192 or scanner 192 and optical element 198. In some such implementations, system 100 may not include one or more other components, such as storage device 108, robot 120, manufacturing tool 126, controller 152, or a combination thereof, as illustrative, non-limiting examples. To illustrate, system 100 that includes scanner 192 and/or optical element 198 may be coupled to a controller (e.g., 152) that is independent of a welding system—e.g., the controller is configured to generate point cloud 169 and does not generate weld instructions 176.

During operation of system 100, controller 152 may be configured to transmit control information 182 to sensor 109, such as scanner 192, to perform a scanning operation. Based on the scanning operation, controller 152 may receive, from a detector (e.g., 210), sensor data 180 or 165 based on detected light. The detected light may include reflections of light based on light projected by one or more emitters (e.g., emitter 205, first laser 510, or second laser 512) and reflected off of an object, such as part 135. Controller 152 may determine, based on sensor data 180, a first-order reflection and a second-order reflection. Additionally, or alternatively, controller 152 may determine, based on the second-order reflection, a difference—e.g., polarity information 154, intensity information 155, angle information 157, or a combination thereof. In some implementations, the difference includes a polarity difference (e.g., 154), an intensity difference (e.g., 155), or a combination thereof. Controller 1152 may be configured to filter the second-order reflection based on the difference to generate filtered image data 156. Controller 152 may generate point cloud 169 based on filtered image data 156. Additionally, or alternatively, controller 152 may perform one or more operations based on filtered image data 156, point cloud 169, or a combination thereof. As an illustrative, non-limiting example, controller 152 may generate weld instruction 176 based on filtered image data 156, point cloud 169, or a combination thereof.

In some implementations, system 100 may be configured to implement a first technique to remove, reject, or filter out one or more reflections. When system 100 is configured to implement the first technique, scanner 192 (or a laser source included in the scanner 192) may project polarized light onto part 135 (e.g., metallic part 135). The projected polarized light may have a first polarity that may include one or more vibrational directions. When the light having first polarity is projected onto part 135, it results in different orders of reflections, such as first-order reflection and second-order reflections. It is noted that the polarity of first- and second-order reflections of the projected laser may be different. For example, the first-order reflection of the projected light may have a polarity that is substantially similar to or the same as the first polarity, and the second-order reflection may have a polarity that is substantially different from the first polarity. To illustrate, as an illustrative, non-limiting example, the polarity of the first-order reflection may be within 5 degrees of the first polarity, and the polarity of the second-order reflection may be different from the second polarity by 45 degrees. In some instances, the polarity difference may be about 90 degrees. These differences in polarities may be identified and/or detected using a detector, such as detector 210. For example, detector 210 may be configured to process one shot/image and capture polarity information 154 of a first-order reflection, a second-order reflection, or a combination thereof. The image captured by the detector may be used by controller 152 to filter out second-order reflections from the captured image(s). Filtering out second-order reflections may result in images that predominantly capture first-order reflections, which may be utilized by controller 152 to more accurately generate a digital representation, such as point cloud 169, of part 135.

Controller 152, in determining or identifying polarity information 154 of the captured light, may extract multiple sub-images, as described herein at least with reference to FIG. 4, corresponding to the order of reflection and their corresponding polarities. For example, controller 152 may determine (e.g., extract)—from the captured one or more images—a first sub-image corresponding to the first-order reflection in accordance with the second polarity. Similarly, controller 152 may determine (e.g., extract)—from the captured one or more images—a second or third or fourth sub-images corresponding to the order of reflection of the light in accordance to their polarity. Additionally, or alternatively, controller 152 may determine (e.g., extract) intensity information 155 associated with or corresponding to the order of reflection associated with the extracted sub-images. For example, controller 152 may also determine (e.g., extract) other data (e.g., intensity information 155) corresponding to the first-order reflection in a sub-image associated with the vibrational direction/polarity of the first-order reflection. Similarly, controller 152 may determine (e.g., extract) intensity information 155 (or other parameters) corresponding to the second-order reflection in a sub-image associated with the vibrational direction/polarity of the second-order reflection. In some implementations, controller 152 may use an intensity difference between the first-order reflection and the second-order reflection to filter out the second-order reflection from the main shot/image. After filtering the second-order reflection, controller 152 may be configured to generate a digital (or 3D) representation, such as point cloud 169, of part 135 based predominantly on the first-order reflection.

Additionally, or alternatively, controller 152 may be configured to determine (e.g., extract) angle of linear polarization information (157) associated with or corresponding to the order of reflection associated with the extracted sub-images. For example, controller 152 may determine (e.g., extract) an angle of linear polarization corresponding to the first-order reflection in a sub-image associated with the vibrational direction/polarity of the first-order reflection. Similarly, controller 152 may determine (e.g., extract) an angle of linear polarization corresponding to the second-order reflection in a sub-image associated with the vibrational direction/polarity of the second-order reflection. In some implementations, controller 152 may use the angle of linear polarization difference between the first-order reflection and the second-order reflection to filter out the second-order reflection from the main shot/image. After filtering, controller 152 may be configured to generate a digital (or 3D) representation, such as point cloud 169, of part 135.

In some implementations, system 100 may be configured to implement a second technique to remove, reject, or filter out one or more reflections. The second technique, such as a “multiple laser technique” may not require using one or more detectors configured to detect the polarity of reflected light. For the second technique, scanner 192 may be configured to include multiple lasers, such as first laser 510 and second laser 512, and detector 210 (e.g., a camera). The laser projection from the multiple lasers (e.g., two or more lasers) may be staggered in time. For example, at or during a first time window, a laser from one of the lasers is projected onto part 135, while at or during a second time window (different from the first time window), the laser from another one of the lasers is projected onto part 135. For the second technique, the detector (e.g., a camera) may include or be coupled to a polarization filter, such as a filter as described at least with reference to FIG. 3. In some implementations, the polarization filter may be coupled to the camera (e.g., may be placed in front of the camera) such that it is replaceable. In other examples, the polarization filter may be positioned inside the camera such that it is not removable or not easily removable or replaceable. In any scenario, the camera may include a polarization filter that has a polarity similar to that of one of the multiple lasers. The polarity of the polarization filter can be viewed as being equivalent to a slit which only passes through electromagnetic waves that are aligned with the slit.

In some implementations of the second technique, system 100 may also include optical element 198, such as one or more mirrors, one or more retarders, one or more beam splitters, one or more lenses, the like, or a combination thereof. Optical element 198 may be configured and/or used to manipulate one or more lasers (e.g., laser light). For example, the laser manipulation may include manipulation of polarity, angle of incidence, filtration of certain vibrational electromagnetic waves, conversion of laser to line, or a combination thereof. In some implementations, optical element 198 may be configured or used to ensure that the laser projected by each of the multiple lasers strike part 135 at a location, such as at the same location. For example, Powell lens 524 may be used to transform the incoming laser beams into laser lines, while also ensuring that the laser lines are incident at the same location on part 135. In some implementations of the second technique, operation of other components, such as fixtures 127 and robot 120, may remain the same as with implementation of the first technique. Controller 152 configured to implement the second technique may also be any suitable machine that is specifically and specially configured (e.g., programmed) to perform or control the actions or operations as described with reference to the second technique.

Referring to FIG. 6, FIG. 6 is a diagram of an example of a technique to filter one or more second- and/or higher order reflections according to one or more aspects. For example, the technique of FIG. 6 may include or correspond to the second technique described above, such as the “multiple laser technique”. As shown, the technique of FIG. 6 is described with reference to two lasers—e.g., a double laser technique to filter out second- and/or higher-order reflections.

For the second technique (described with reference to FIG. 6), the polarities of the two lasers incident to part 135 (e.g., a metallic part) are substantially or approximately orthogonal (e.g., 90 degrees) to each other. For example, laser 1 (e.g., first laser 510) and laser 2 (e.g., second laser 512), as shown in FIG. 6, may project lasers having polarities P1 and P2, respectively, which may be orthogonal with respect to each other. A first-order reflection (referred to as type 1 reflection polarization in FIG. 6) of the projected first laser of laser 1 (e.g., reflection from part 135) may have a polarity that is substantially similar to the polarity of the projected first laser, and a second-order reflection (referred to as type 2 reflection polarization in FIG. 6) of the projected first laser may have a polarity that is substantially different from the polarity of the projected first laser. Similarly, a first-order reflection of the projected second laser of laser 2 (e.g., reflection from part 135) may have a polarity that is substantially similar to the polarity of the projected second laser, and a second-order reflection of the projected second laser may have a polarity that is substantially different from the polarity of the projected second laser. A camera, such as detector 210, may include a polarization filter that has a polarity similar to that of laser 1. The polarization filter can be viewed as acting as a slit which only passes through electromagnetic waves that are aligned with the slit.

In operation, at time t1, the projection of first laser of laser 1 onto part 135 may result in first- and second-order reflections. The image (also referred to herein as the first image) captured by the camera at t1 may show the first-order reflection having higher intensity than the second-order reflection. This intensity difference may occur because the polarity of the polarization filter is similar to that of the polarity of first laser of laser 1. This similarity in polarities means that more of the first-order reflection is captured by the camera than the second-order reflection. The same principle applies with respect to the second laser of laser 2, which may be projected at time t2. That is, because of the presence of the polarization filter having a polarity similar to that of the first laser, the image (also referred to herein as the second image) captured by the camera at t2 may show the first-order reflection of the second laser having lower intensity than the second-order reflection. The difference in intensities between the second-order reflections associated with the first laser and the second laser could be used to filter the second-order reflections. For example, the imaged lasers that went from having low intensity for the first laser in the first image and high intensity for the second laser in the second image could be identified and/or characterized as second-order reflections, and therefore be filtered out. On the other hand, the lasers that went from having high intensity for the first laser in the first image and low intensity for the second laser in the second image could be identified and/or characterized as first-order reflections, and therefore be used to generate a 3D representation of part 135.

Referring back to FIG. 1, in some implementations, controller 152 may be configured to perform or implement the first technique, the second technique, or a combination thereof. For example, controller 152 may be configured to implement the first technique followed by the second technique. Alternatively, controller 152 may be configured to implement the second technique followed by the first technique. Additionally, or alternatively, controller 152 may be configured to implement the first technique as part of implementing the second technique.

In some implementations, a system (e.g., 100 or 110) includes controller 152 configured to receive, from a detector 210, sensor data 180 based on detected light. The detected light includes reflections of light (e.g., 225, 235, 255) projected by one or more emitters 205 (or 510 or 512) and reflected off of part 135. Controller 152 is further configured to determine, based on sensor data 180, a first-order reflection and a second-order reflection. Controller 152 is also configured to determine, based on the second-order reflection, a difference (e.g., polarity information 154, intensity information 155, or angle information 157). The difference includes a polarity difference (e.g., polarity information 154), an intensity difference (e.g., intensity information 155), or a combination thereof. Controller 152 is further configured to filter the second-order reflection based on the difference.

In some implementations, a system (e.g., 100) includes a laser source (e.g., emitter 205, first laser 510, or second laser 512), detector 210, and a controller 152 (or 110) communicatively coupled to detector 210 and the laser source (e.g., 205, 510, or 512). The laser source is configured to project polarized light (e.g., 215) onto a metallic part (e.g., 135 or 136). The metallic part is configured to cast multiple reflections (e.g., 225, 235, 255) following projection of the polarized light. The projected laser light has a first polarity. A first-order reflection from the multiple reflections has a second polarity that is substantially similar to the first polarity. A second-order reflection from the multiple reflections has a third polarity that is substantially different from the first polarity. The detector is configured to detect the first-order reflection based on the second polarity, and the second-order reflection based on the third polarity. The controller 152 is configured to filter the second-order reflection based at least in part on a difference (e.g., polarity information 154) in the second polarity and the third polarity.

In some implementations, a system (e.g., 100) includes a first laser unit (e.g., first laser 510), a second laser unit (e.g., second laser 512), an optical lens (e.g., Powell lens 524), a camera (e.g., sensor 109 or detector 210), and a controller 152 (or 110). The first laser unit is configured to generate first polarized light having a first polarity. The second laser unit is configured to generate second polarized light having a second polarity. The second polarity is orthogonal to the first polarity. The optical lens is configured to receive the first polarized light and transmit a first laser line at a first location on a metallic object (e.g., 135 or 136). The first laser line has a polarity that is substantially similar to the first polarity. The optical lens is also configured to receive the second polarized light and transmit a second laser line at the first location on the metallic object. The second laser line has a polarity that is substantially similar to the second polarity. A first-order reflection of the first laser line has a third polarity that is substantially similar to the first polarity. A second-order reflection of the first laser line has a fourth polarity that is substantially different from the first polarity. A first-order reflection of the second laser line has a fifth polarity that is substantially similar to the second polarity. A second-order reflection of the second laser line has a sixth polarity that is substantially different from the second polarity. The camera has an optical filter coupled thereto. The optical filter may include or correspond to the optical filter as described at least with reference to FIG. 3. The optical filter is configured to pass through more light having the first polarity than the second polarity. The controller is communicatively coupled to the camera. The controller configured to instruct (e.g., control information 182) the detector to generate the first polarized light at a first time window and capture a first one or more images, such as sensor data 180, sensor data 165, or image data 153, of the metallic object during the first time window. The first one or more images captured during the first time window include the first-order reflection of the first laser line having a first intensity and the second-order reflection of the first laser line having a second intensity. The controller is further configured to instruct the detector to generate the second polarized light at a second time window and capture a second one or more images, such as sensor data 180, sensor data 165, or image data 153, of the metallic object during the second time window. The second one or more images captured during the second first time window includes the first-order reflection of the second laser line having a thief intensity and the second-order reflection of the second laser line having a fourth intensity. The controller is also configured to instruct the detector to identify the second-order reflection of the first laser line and second-order reflection of the second laser line based at least in part on a difference between the second intensity and the fourth intensity (e.g., intensity information 155).

As described with reference to FIG. 1, the present disclosure provides techniques for supporting an optical system. The techniques may use a reflection refuting laser scanner for rejecting certain reflections when scanning an object. For example, the techniques described enable a system to accurately scan and image a reflective object (e.g., 135 or 136) to allow for accurate generation of a digital representation (e.g., point cloud 169) of the objects. The digital representation may then be relied on for performing additional operations, such as seam recognition, path planning, or an autonomous welding operation, as illustrative, non-limiting examples.

Referring to FIG. 7, FIG. 7 is a block diagram illustrating another system 700 configured to implement an optical system according to one or more aspects. System 700 may include or correspond to system 100 of FIG. 1. The optical system may include or correspond to sensor 109, scanner 192, optical element 198, emitter 205, detector 210, first laser 510, second laser 512, retarder 520, beam splitter 522, Powell lens 524, mirror 526, a camera, or a combination thereof.

As compared to system 100 of FIG. 1, system 700 shows additional aspects of control system 110. To illustrate, control system 110 may include a controller 152, one or more input/output (110) and communication adapters 704 (hereinafter referred to collectively as “I/O and communication adapter 704”), one or more user interface and/or display adapters 706 (hereinafter referred to collectively as “user interface and display adapter 706”), and one or more sensors 109 (hereinafter referred to ss “sensor 109”).

In some implementations, controller 152 may also be configured to control other aspects of system 700. For example, controller 152 may further interact with user interface (UI) and display adapter 706. To illustrate, controller 152 may provide a graphical interface on UI and display adapter 706 by which a user may interact with system 700 and provide inputs to system 700 and by which controller 152 may interact with the user, such as by providing and/or receiving various types of information to and/or from a user (e.g., identified seams that are candidates for welding, possible paths during path planning, welding parameter options or selections, etc.). UI and display adapter 706 may be any type of interface, including a touchscreen interface, a voice-activated interface, a keypad interface, a combination thereof, etc.

In some implementations, control system 110 may include a bus (not shown). The bus may be configured to couple, electrically or communicatively, one or more components of control system 110. For example, the bus may couple controller 152, processor 101, memory 102, I/O and communication adapter 704, and user interface and display adapter 706. Additionally, or alternatively, the bus may couple one or more components or portions of controller 152, processor 101, memory 102, I/O and communication adapter 704, and user interface and display adapter 706.

Memory 102 includes or is configured to store instructions 103 and information 164. Memory 102 includes or is configured to store other information or data, such as a design 770, joint model information 771, one or more waypoints 772, a bead model 773, a cross-sectional weld profile 774, and a weld fill plan 775.

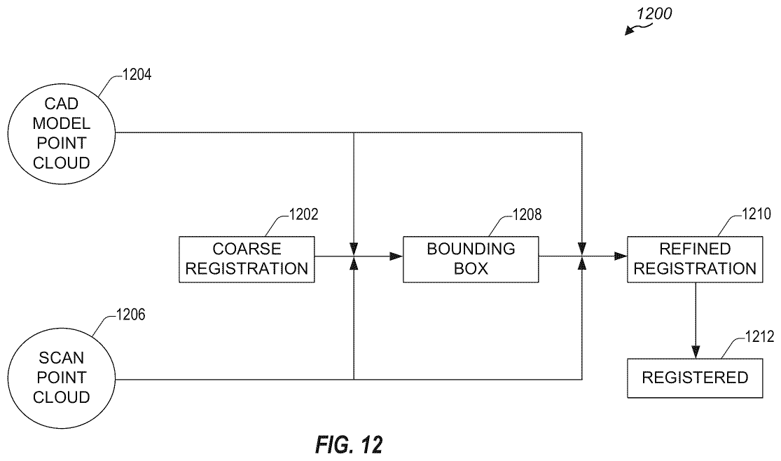

Instructions 103 may include path planning logic 705, machine learning logic 707, and multipass logic 711. Additionally, or alternatively, instructions 103 may include other logic, such as registration logic as described further herein at least with reference to FIG. 12. Although shown as separate logical blocks, path planning logic 705, machine learning logic 707, and/or multipass logic 711 may be part of memory 102 and may include the program code (and data associated therewith) for performing functions of path planning machine learning, and single pass or multipass operations, respectively. For example, path planning logic 705 is configured to generating a path for robot 120 along a seam, including but not limited to, optimizing movements of robot 120 to complete a weld. Additionally, or alternatively although shown as separate logical blocks, path planning logic 705, machine learning logic 707, and multipass logic 711 may be combined. Further, other logic (e.g., registration logic) may be included or combined with, path planning logic 705, machine learning logic 707, and multipass logic 711.

As an illustrate, non-limiting example, path planning logic 705 may be configured for graph-matching or graph-search approaches to generate a path or trajectory conforming to an identified seam. In the case of welding, the task of welding with a weld head coupled to a robotic arm may be specified in 5 degrees of freedom. The hardware capability of the system (robotic arm's 5 degrees of freedom) exceeds 5 degrees of freedom. In some implementations, path planning logic 705 may perform a search using more than 5 degrees of freedom, such as when considering collision avoidance. There are multiple ways to work around this redundancy, first being to constrain the over-actuated system by specifying the task in a higher dimension, or utilize the redundancy and explore multiple options. Conventionally, path planning has been generally posed as a graph search problem. It may be considered over-actuated planning, and in some implementations, the redundant degree(s) of freedom can be discretized and each sample can be treated as a unique node in building a graph. The structure of the resulting graph may allow for fast graph search algorithms. Each point on the seam can be considered as a layer in the graph, similar to the rungs of a ladder. The nature of the path planning problem is such that the robot must always transition between these rungs in the forward direction. This is the first aspect of the problem that makes graph search simpler. Path planning logic 705 generates multiple joint space solutions for each point on the seam. All the solutions for a given point belong to the same layer. There is no point for a robot to transition between different solutions of the same rung, hence, in the graph, these nodes are not connected. This adds further restrictions on the structure of the graph.

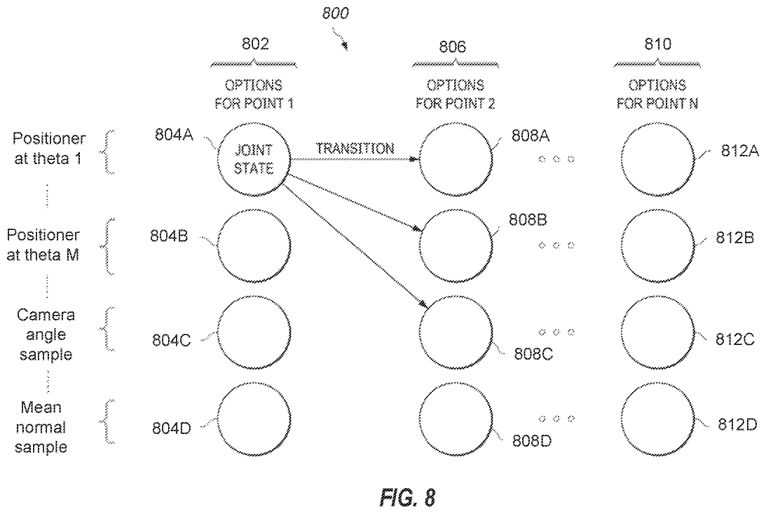

Referring to FIG. 8, FIG. 8 is a schematic diagram 800 of a graph-search technique according to one or more aspects. In some implementations, schematic diagram represents a graph-search technique by which the path plan for robot 120 may be determined (e.g., controller 152). For example, the graph-search technique may be performed using path planning logic 705.

In some implementations, each circle in the diagram 800 represents a different state of robot 120, such as a configuration of joints (of robot 120) that satisfies welding requirements, as illustrative, non-limiting examples. Each arrow is a path that the robot can take to travel along the seam. To illustrate, each circle may be a specific location of robot 120 (e.g., the location of a weld head of robot 120 in 3D space) within workspace 130 and a different configuration of an arm of robot 120, as well as a position or configuration of a fixture supporting the part, such as a positioner, clamp, etc. Each column 802, 806, and 810 represents a different point, such as a waypoint, along a seam to be welded. Thus, for the seam point corresponding to column 802, robot 120 may be in any one of states 804A-804D. Similarly, for the seam point corresponding to column 806, robot 120 may be in any one of states 808A-808D. Likewise, for the seam point corresponding to column 810, robot 120 may be in any one of states 812A-812D. If, for example, robot 120 is in state 804A when at the seam point corresponding to column 802, robot 120 may then transition to any of the states 808A-808D for the next seam point corresponding to the column 806. Similarly, upon entering a state 808A-808D, robot 120 may subsequently transition to any of the states 812A-812D for the next seam point corresponding to the column 810, and so on. In some examples, entering a particular state may preclude entering other states. For example, entering state 804A may permit the possibility of subsequently entering states 808A-808C, but not 808D, whereas entering state 804B may permit the possibility of subsequently entering states 808C and 808D, but not states 808A-808B. The scope of this disclosure is not limited to any particular number of seam points or any particular number of robot states.

In some examples, to determine a path plan for robot 120 using the graph-search technique (e.g., according to the technique depicted in diagram 800), controller 152, such as path planning logic 705, may determine the shortest path from a state 804A-804D to a state corresponding to a seam point N (e.g., a state 812A-812D). By assigning a cost to each state and each transition between states, an objective function can be designed by a user or controller 152. The controller 152 finds the path that results in the least possible cost value for the objective function. Due to the freedom of having multiple starts and endpoints to choose from, graph search methods like Dijkstra's algorithm or A* may be implemented. In some examples, a brute force method may be useful to determine a suitable path plan. The brute force technique would entail control system 110 (e.g., controller 152 or processor 101) computing all possible paths (e.g., through the diagram 800) and choosing the shortest one (e.g., by minimizing or maximizing the objective function). Simply put, the brute force method would compute all the possible paths through this graph and choose the shortest one. The complexity of the brute force method may be O(E), where E is the number of edges in the graph. Assuming N points in a seam with M options per point. Between any two layers, there are M*M edges. Hence, considering all layers, there are N*M*M edges. The time complexity is O(NM\hat{ }2), or O(E).

Controller 152, such as path planning logic 705, may determine whether the state at each seam point is feasible, meaning at least in part that controller 152 may determine whether implementing the chain of states along the sequence of seam points of the seam will cause any collisions between robot 120 and structures in workspace 130, or even with parts of robot 120 itself. To this end, the concept of realizing different states at different points of a seam may alternatively be expressed in the context of a seam that has multiple waypoints, such as waypoints 772.

In some implementations, controller 152 may discretize an identified seam into a sequence of waypoints. A waypoint may constrain an orientation of the weld head connected to the robot 120 in three (spatial/translational) degrees of freedom. Typically, constraints in orientation of the weld head of the robot 120 are provided in one or two rotational degrees of freedom about each waypoint, for the purpose of producing some desired weld of some quality; the constraints are typically relative to the surface normal vectors emanating from the waypoints and the path of the weld seam. For example, the position of the weld head can be constrained in x-, y-, and z-axes, as well as about one or two rotational axes perpendicular to an axis of the weld wire or tip of the welder, all relative to the waypoint and some nominal coordinate system attached to it. These constraints, in some examples, may be bounds or acceptable ranges for the angles. Those skilled in the art will recognize that the ideal or desired weld angle may vary based on part or seam geometry, the direction of gravity relative to the seam, and other factors. In some examples, controller 152 may constrain in a first position or a second position to ensure that the seam is perpendicular to gravity for one or more reasons (such as to find a balance between welding and path planning for optimization purposes). The position of the weld head can therefore be held (constrained) by each waypoint at any suitable orientation relative to the seam. Typically, the weld head will be unconstrained about a rotational axis (θ) coaxial with an axis of the weld head. For instance, each waypoint can define a position of the weld head of the welding robot 120 such that at each waypoint, the weld head is in a fixed position and orientation relative to the weld seam. In some implementations, the waypoints are discretized finely enough to make the movement of the weld head substantially continuous.

In some implementations, controller 152 may divide each waypoint into multiple nodes. Each node can represent a possible orientation of the weld head at that waypoint. As an illustrative, non-limiting example, the weld head can be unconstrained about a rotational axis coaxial with the axis of the weld head such that the weld head can rotate (e.g., 360 degrees) along a rotational axis θ at each waypoint. Each waypoint can be divided into 20 nodes, such that each node of each waypoint represents the weld head at 18 degree of rotation increments. For instance, a first waypoint-node pair can represent rotation of the weld head at 0 degrees, a second waypoint-node pair can represent rotation of the weld head at from 18 degrees, a third waypoint-node pair can represent rotation of the weld head at 36 degrees, etc. Each waypoint can be divided into 2, 10, 20, 60, 120, 360, or any suitable number of nodes. The subdivision of nodes can represent the division of orientations in more than 1 degree of freedom. For example, the orientation of the welder tip about the waypoint can be defined by 3 angles. A weld path can be defined by linking each waypoint-node pair. Thus, the distance between waypoints and the offset between adjacent waypoint nodes can represent an amount of translation and rotation of the weld head as the weld head moves between node-waypoint pairs.

Controller 152, such as path planning logic 705, can evaluate each waypoint-node pair for feasibility of welding. For instance, if a waypoint is divided into 20 nodes, controller 152 can evaluate whether the first waypoint-node pair representing the weld head held at 0 degrees would be feasible. Stated differently, controller 152 can evaluate whether robot 120 would collide or interfere with a part (135, 136), fixture 127, or the welding robot itself, if placed at the position and orientation defined by that waypoint-node pair. In a similar manner, controller 152 can evaluate whether the second waypoint-node pair, third waypoint-node pair, etc., would be feasible. Controller 152 can evaluate each waypoint similarly. In this way, all feasible nodes of all waypoints can be determined.

In some examples, a collision analysis as described herein may be performed by comparing a 3D model of workspace 130 and a 3D model of robot 120 to determine whether the two models overlap, and optionally, some or all of the triangles overlap. The 3D model of workspace, the 3D model of robot 120, or both, may be stored at memory 102, or storage device 108, as illustrative, non-limiting examples. If the two models overlap, controller 152 may determine that a collision is likely. If the two models do not overlap, controller 152 may determine that a collision is unlikely. More specifically, in some examples, controller 152 may compare the models for each of a set of waypoint-node pairs (such as the waypoint node pairs described above) and determine that the two models overlap for a subset, or even possibly all, of the waypoint-node pairs. For the subset of waypoint-node pairs with respect to which model intersection is identified, controller 152 may omit the waypoint-node pairs in that subset from the planned path and may identify alternatives to those waypoint-node pairs. Controller 152 may repeat this process as needed until a collision-free path has been planned. Controller 152 may use a flexible collision library (FCL), which includes various techniques for efficient collision detection and proximity computations, as a tool in the collision avoidance analysis. The FCL may be stored at memory 102 or storage device 108, as illustrative, non-limiting examples. The FCL is useful to perform multiple proximity queries on different model representations, and it may be used to perform probabilistic collision identification between point clouds. Additional or alternative resources may be used in conjunction with or in lieu of the FCL.

Controller 152 can generate one or more feasible simulate (or evaluate, both terms used interchangeably herein) weld paths should they physically be feasible. A weld path can be a path that the welding robot (e.g., 120) takes to weld a seam. In some examples, the weld path may include all the waypoints of a seam. Alternatively, the weld path may include some but not all the waypoints of the seam. The weld path can include the motion of robot 120 and the weld head as the weld head moves between each waypoint-node pair. Once a feasible path between node waypoint pairs is identified, a feasible node-waypoint pair for the next sequential waypoint can be identified should it exist. Those skilled in the art will recognize that many search trees or other strategies may be employed to evaluate the space of feasible node-waypoint pairs. Additionally, or alternatively, as discussed herein, a cost parameter can be assigned or calculated for movement from each node-waypoint pair to a subsequent node-waypoint pair. The cost parameter can be associated with a time to move, an amount of movement (e.g., including rotation) between node-waypoint pairs, and/or a simulated/expected weld quality produced by the weld head during the movement.

In instances in which no nodes are feasible for welding for one or more waypoints and/or no feasible path exists to move between a previous waypoint-node pair and any of the waypoint-node pairs of a particular waypoint, controller 152, such as path planning logic 705, can determine alternative welding parameters such that at least some additional waypoint-node pairs become feasible for welding. For example, if controller 152 determines that none of the waypoint-node pairs for a first waypoint are feasible, thereby making the first waypoint unweldable, controller 152 can determine an alternative welding parameters, such as an alternative weld angle so that at least some waypoint-node pairs for the first waypoint become weldable. For example, controller 152 can remove or relax the constraints on rotation about the x and/or y axis. Similarly stated, controller 152 can allow the weld angle to vary in one or two additional rotational (angular) dimensions. For example, controller 152 can divide a waypoint that is unweldable into two- or three-dimensional nodes. Each node can then be evaluated for welding feasibility of the welding robot and weld held in various weld angles and rotational states. The additional rotation about the x- and/or y-axes or other degrees of freedom may make the waypoints accessible to the weld head such that the weld head does not encounter any collision. In some implementations, controller 152—in instances in which no nodes are feasible for welding for one or more waypoints and/or no feasible path exists to move between a previous waypoint-node pair and any of the waypoint-node pairs of a particular waypoint—can use the degrees of freedom in determining feasible paths between a previous waypoint-node pair and any of the waypoint-node pairs of a particular waypoint.

Based on the generated weld paths, controller 152 can optimize the weld path for welding. As used herein, Optimal and optimize do not refer to determining an absolute best weld path, but generally refers to techniques by which weld time can be decreased and/or weld quality improved relative to less efficient weld paths. To illustrate, controller 152 can determine a cost function that seeks local and/or global minima for the motion of robot 120. Typically, the optimal weld path minimizes weld head rotation, as weld head rotation can increase the time to weld a seam and/or decrease weld quality. Accordingly, optimizing the weld path can include determining a weld path through a maximum number of waypoints with a minimum amount of rotation.

In evaluating the feasibility of welding at each of the divided nodes or node waypoint pairs, controller 152 may perform multiple computations. In some examples, each of the multiple computations may be mutually exclusive from one another. In some examples, the first computation may include kinematic feasibility computation, which computes for whether the arm of robot 120 of the welding robot being employed can mechanically reach (or exist) at the state defined by the node or node-waypoint pair. In some examples, in addition to the first computation, a second computation—which may be mutually exclusive to the first computation—may also be performed by controller 152. The second computation may include determining whether the arm of robot 120 will encounter a collision (e.g., collide with workspace 130 or a structure in workspace 130) when accessing the portion of the seam (e.g., the node or node-waypoint pair in question).

Controller 152, such as path planning logic 705, may perform the first computation before performing the second computation. In some examples, the second computation may be performed only if the result of the first computation is positive (e.g., if it is determined that the arm of robot 120 can mechanically reach (or exist) at the state defined by the node or node-waypoint pair). In some examples, the second computation may not be performed if the result of the first computation is negative (e.g., if it is determined that the arm of robot 120 cannot mechanically reach (or exist) at the state defined by the node or node-waypoint pair).

The kinematic feasibility may correlate with the type of robotic arm employed. In some implementations, welding robot 120 includes a six-axis robotic welding arm with a spherical wrist. The six-axis robotic arm can have 6 degrees of freedom—three degrees of freedom in X-, Y-, Z-cartesian coordinates and three additional degrees of freedom because of the wrist-like nature of robot 120. For example, the wrist-like nature of robot 120 results in a fourth degree of freedom in wrist-up/-down manner (e.g., wrist moving in +y and −y direction), a fifth degree of freedom in wrist-side manner (e.g., wrist moving in −x and +x direction), and sixth degree of freedom in rotation. In some examples, the welding torch is attached to the wrist portion of robot 120.

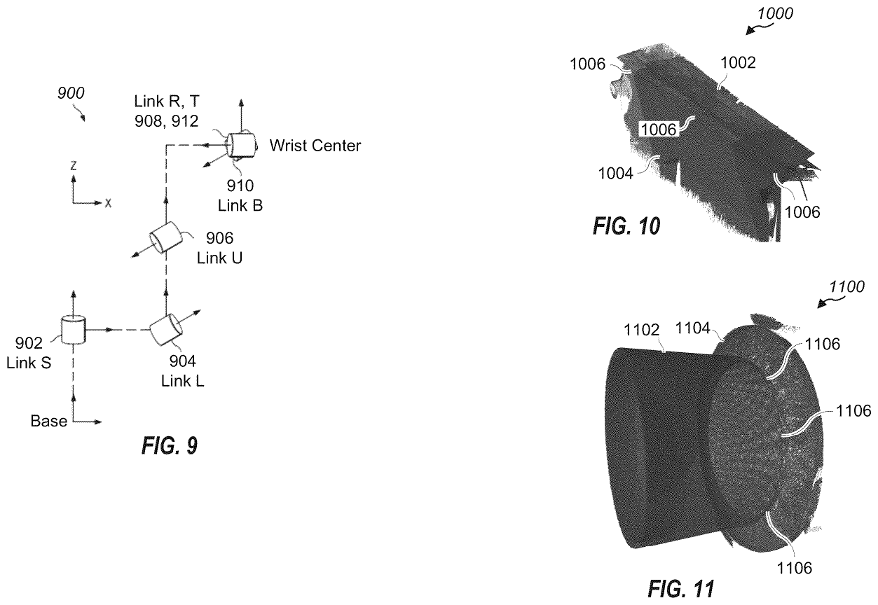

To determine whether the arm of robot 120 being employed can mechanically reach (or exist) at the state defined by the node or node-waypoint pair—e.g., to perform the first computation—robot 120 may be mathematically modeled. An example of a representation 900 of a robotic arm according to one or more aspects is shown with reference to FIG. 9. In some examples, controller 152, such as path planning logic 705, may solve for the first three joint variables based on a wrist position and solve for the other three joint variables based on wrist orientation. It is noted that a torch (e.g., a weld head) is attached rigidly on the wrist. Accordingly, the transformation between torch tip and wrist is assumed to be fixed. Referring to FIG. 9, representation 900 of the robotic arm includes a base, a wrist center, and links B 910, L 904, R 908, S 902, T 912, and U 906, which may be considered as joint variables. To find the first three joint variables (e.g., variables S, L, U at 902, 904, 906, respectively), the geometric approach (e.g., law of cosine) may be employed.

After the first three joint variables (i.e., S, L, U) are computed successfully, controller 152 may then solve for the last three joint variables (i.e., R, B, T at 908, 910, 912, respectively) by, for example, considering wrist orientation as a Z-Y-Z Euler angle. Controller 152 may consider some offsets in robot 120. These offsets may need to be considered and accounted for because of inconsistencies in the unified robot description format (URDF) file. For example, in some examples, values (e.g., a joint's X axis) of the position of a joint (e.g., actual joint of robot 120) may not be consistent with the value noted in its URDF file. Such offset values may be provided to controller 152 in a table, such as a data stored at memory 102 or storage device 108. Controller 152, in some examples, may consider these offset values while mathematically modeling robot 120. In some examples, after robot 120 is mathematically modeled, controller 152 may determine whether the arm of robot 120 can mechanically reach (or exist) at the states defined by the node or node-waypoint pair.

As noted above, controller 152 can evaluate whether robot 120 would collide or interfere with one or more parts (135, 136), fixture 127, or anything else in workspace 130, including robot 120 itself, if placed at the position and orientation defined by that waypoint-node pair. Once controller 152 determines the states in which the robotic arm can exist, controller 152 may perform the foregoing evaluation (e.g., regarding whether the robot would collide something in its environment) using the second computation.

Referring back to FIG. 7, machine learning logic 707 is configured to learn from and adapt to a result based on one or more welding operations performed by robot 120. During or based on operation of system 100, a machine learning logic (e.g., machine learning logic 707) is provided with sensor data 180 associated with at least a portion of a weld formed by robot 120. For example, sensor data 180 may indicate one or more spatial characteristics of a weld. In some implementations, the portion of the weld may include or correspond to one or more passes of a multipass welding operation.

In some implementations, machine learning logic 707 is configured to update a model, such as bead model 773 or a welding model, based on sensor data 180. For example, bead model 773 may be configured to predict a profile of a bead and the welding model may be configured to generate one or more weld instructions (e.g., 176) to achieve the profile of the bead or a weld fill plan (e.g., 775). Controller 152 may generate a first set of weld instructions based on bead model 773, the welding model, or a combination thereof. After execution of the first set of weld instructions by robot 120, controller 152 may receive feedback information (e.g., sensor data 180). Machine learning logic 707 may update bead model 773 or the welding model based on the feedback. Updating bead model 773 or the welding model may involve minimizing an error function that describes the difference between a predicted shape and the shape that is observed after execution. For example, machine learning logic 707 may formulate the error as an L2 norm.

Multipass logic 711 is configured to determine a weld fill plan that includes multiple weld passes for a seam. For example, controller 152 may execute multipass logic 711 to generate one or more welding profiles (e.g., 774), a weld fill plan (e.g., 775), one or more weld instructions (e.g., 176), or a combination thereof, as described further herein.

Design 770 may include or indicate a CAD model of one or more parts. In some implementations, the CAD model may be annotated with or indicate one or more weld parameters, a geometry or shape of a weld, dimensions, tolerances, or a combination thereof. Joint model information 771 may include or indicate a plurality of feature components. The plurality of features components may indicate or be combined to indicate a joint model. In some implementations, each feature component of the plurality of feature components includes a feature point, a feature point vector, a tolerance, or a combination thereof. One or more waypoints 772 may include, indicate, or correspond to a location along seam 144.

Bead model 773 is configured to model an interaction of a bead weld placed on a surface. For example, bead model 773 may indicate a resulting bead profile or cross-sectional area of a bead weld placed on the surface. In some implementations, bead model is a first order model that models formation of a bead weld based on an energy source and change of a shape or profile (e.g., an exposed bead cap) of the bead weld.

In some implementations, bead model 773 may be configured to indicate or relate energy sources or sinks associated with a bead that push and pull on an exposed bead cap. Bead model 773 may relate a radius of influence on each energy source or sink has on one or more points of the exposed bead cap. Bead model 773 may also include a weighting face that can be applied to its normal based on equating the influence of each energy source and sink. It is noted that movement along its normal can emulate how area of a bead weld can be redistributed along a surface.

Bead model 773 may also link an end of the expanded bead cap to the surface—e.g., a toe contact angle. To model the toe contact angle, bead model 773 may account for or factor surface tension, torch angle, aspect ratio, or a combination thereof. The surface tension may be associated with pressure on a bead (on a plate) due to gravity. The torch angle may represent a work angle and, therefore, an arc distribution. The closer the torch is to the surface, the greater the temperature of the weld pool which decreases surface tension in a direction of the torch and increases a wetting effect. The aspect ratio may represent an effect that voltage can have on the arc cone angle causing wetting to be more or less pronounced. Bead model 773 may use a first order system model to control the convergence of the bad cap into the wetted toe point.

In some implementations, bead model 773 models energy sources using equations:

$${r}_{p} = p - {o}_{i} \\ {u}_{r} = \frac{{r}_{p}}{‖ {r}_{p} ‖} \\ {α}_{p} = \vert {N}_{p} \cdot {u}_{r} \vert \\ {A}_{p}^{i} = \frac{{A}_{i}}{\vert {A}_{i} \vert \times {A}_{p}} \\ {f}_{o} ( x ) = \frac{1}{σ \sqrt{2 π}} {e}^{( - {x}^{2} / 2 {σ}^{2} )} \\ {E}_{p}^{i} = {f}_{o} ( ‖ {r}_{p} ‖ ) {α}_{p} {A}_{p}^{i} \\ {E}_{p}^{g} = {β}_{g} {N}_{p} \cdot g \\ {w}_{p} = {\sum }_{i} {E}_{p}^{i} ( 1 + {E}_{p}^{g} ) \\ J ( β ) = {A}_{bead} - {A}^{*} ( β w ) \\ {min}_{β ∈ B} J ( β ) = 0$$

and models the toe contact angle based on equations:

$${r}_{toe} = {p}_{toe} - p \\ {r}_{com} = {p}_{toe} - {o}_{com} \\ {δ}_{AR} ( {w}_{bead} , {h}_{bead} ) = {w}_{bead} {C}_{AR} ( 1 - {e}^{{AR}_{nominal} - \frac{{w}_{bead}}{{h}_{bead}}} ) \\ {δ}_{WA} ( {d}_{CTWD} , {h}_{bead} , {u}_{torch} , {r}_{toe} ) = {d}_{CTWD} {C}_{WA} ( 1 - {e}^{\frac{- {β}_{WA}}{{h}_{bead} + ‖ {r}_{toe} ‖} {r}_{toe} \cdot {u}_{torch}} ) \\ {δ}_{ST} ( {h}_{bead} , g , {r}_{com} ) = {h}_{bead} {C}_{ST} ‖ g ‖ ( 1 - {e}^{\frac{{β}_{st}}{{h}_{bead} + ‖ {r}_{com} ‖} {r}_{com} \cdot g} ) \\ x = [ {h}_{bead} , {w}_{bead} , {d}_{CTWD} , g , {u}_{torch} , {r}_{toe} , {r}_{com} ] \\ {δ}_{wetting} ( x ) = {δ}_{AR} + {δ}_{WA} + {δ}_{ST} \\ ∀ x ∈ [ 0 , 1 ] \\ {β}_{1} ∈ [ 0 , ∞ ) \\ {β}_{2} ∈ ( 0 , ∞ ) \\ {r}_{toe}^{i} = {p}_{toe} - {p}_{i} \\ {α}_{i} ( x ) = {e}^{1 - ( 1 + {β}_{1} ) ( {β}_{2} \frac{s ( x )}{max ( s )} + 1 )} \\ {p}_{i}^{′} ( x ) = {p}_{i} + {α}_{i} ( x ) {r}_{toe}^{i}$$

where p is a 2D point along a bead segment, Aₚ is the area of a closest internal source at p, Nₚ is the normal of the bead cap at p, oᵢ is the center of mass of the ith energy source, Aᵢ is the area of the ith energy source, σ is a radius of the influence for each energy source, A_{bead} is a parameterized area of the bead model, w_{bead} is a parameterized width of the bead model, h_{bead} is a parameterized height of the bead model, g is a unit vector of gravity in the local reference frame, A* is the functional representing the area distribution algorithm, β is a scalar constant value, C is a scalar constant value, AR is the aspect ratio of a bead (w/h), u_{torch} is the unit vector of the work angle originating from the bead origin, d_{CTWD} is a magnitude of the contact tip to work distance, and s(x) is the arc length of the bead cap segment.

In some implementations, bead model 773 may take the shape of a parameterized curvature model. The parameterization of bead model 773 may help maintain a core shape that can be adjusted to properly model various characteristics under different conditions. Additionally, a beam may be modeled or altered based on one or more interaction models such that a shape profile of the bead can be created with increased accuracy and stability. In some implementations, data may be collected from various testing and experiments to be analyzed and annotated for essential geometric measurements. These measurements may be used in a regression model to associate a bead width and a bead height or aspect ratio, as well as the area with a set of welding parameters.

Cross-sectional weld profile 774 (also referred to herein as “weld profile 774”) may include or indicate a cross-section of seam 144, such as a cross-section of seam 144 that includes weld material. Weld profile 774 may correspond to a waypoint of one or more waypoints 772. In some implementations, weld profile may include or indicate a joint model, one or more weld beads or weld be locations, or a combination thereof. Weld fill plan 775 indicates one or more fill parameters, one or more weld bead parameters (e.g., one or more weld bead profiles), or a combination thereof. The one or more fill parameters may include or indicate a number of beads, a sequence of beads, a number of layers, a fill area, a cover profile shape, a weld size, or a combination thereof, as illustrative, non-limiting examples. The one or more weld bead parameters may include or indicate a bead size (e.g., a height, width, or distribution, a bead spatial property (e.g., a bead origin or a bead orientation), or a combination thereof, as illustrative, non-limiting examples. Additionally, or alternatively, weld fill plan 775 may include or indicate one or more welding parameters for forming one or more weld beads. The one or more welding parameters may include or indicate a wire feed speed, a travel speed, a travel angle, a work angle (e.g., torch angle), a weld mode (e.g., a waveform), a welding technique (e.g., TIG or MIG), a voltage or current, a contact tip to work distance (CTWD) offset, a weave or motion parameter (e.g., a weave type, a weave amplitude characteristic, a weave frequency characteristic, or a phase lag), a wire property (a wire diameter or a wire type—composition/material), a gas mixture, a heat input, or a combination thereof, as illustrative, non-limiting examples.

Weld fill plan 775 may be generated based on one or more weld profiles 774, one or more bead models 773, one or more contextual variables, or a combination thereof. The one or more contextual variables may be associated with or correspond to a joint model. In some implementations, the one or more contextual variables include or indicate gravity, surface tension, gaps, tacks, surface features, joint features, part material properties or dimensions, or a combination thereof.

Weld instructions 176 may include or indicate one or more operations to be performed by robot 120. Weld instructions 176 may be generated based on one or more weld profiles 774, weld fill plan 775, or a combination thereof.

In some implementations, controller 152 is configured to optimize weld fill plan 775 including its beads/welding commands (e.g., 176) based on context specific welding styles in the form of rules formed from application specific requests/needs. Additionally, or alternatively, controller 152 may be configured to determine weld fill plan 775 accounting for or based on additional capabilities including motion capabilities (weaves), additional welding strategies (such as welding tacks), or a combination thereof.

Communications adapter 704 is configured to couple control system 110 to a network (e.g., a cellular communication network, a LAN, WAN, the Internet, etc.). Communications adapter 704 of embodiments may, for example, comprise a WiFi network adaptor, a Bluetooth interface, a cellular communication interface, a mesh network interface (e.g., ZigBee, Z-Wave, etc.), a network interface card (NIC), and/or the like. User interface adapter and display adapter 706 of the illustrated embodiment may be utilized to facilitate user interaction with control system 110. For example, user interface and display adapter 706 may couple one or more user input devices (e.g., keyboard, pointing device, touch pad, microphone, etc.) to control system 110 for facilitating user input when desired (e.g., when gathering information regarding one or more weld parameters).

In some implementations, I/O and communication adapter 704 may also couple sensor(s) 109 (e.g., global sensor, local sensor, etc.) to processor 101 and memory 102, such as for use with respect to the system detecting and otherwise determining seam location. I/O and communication adapter 704 may additionally or alternatively provide coupling of various other devices, such as a printer (e.g., dot matrix printer, laser printer, inkjet printer, thermal printer, etc.), to facilitate desired functionality (e.g., allow the system to print paper copies of information such as planned trajectories, results of learning operations, and/or other information and documents).

User interface and display adapter 706 may be configured to couple one or more user output devices (e.g., flat panel display, touch screen, heads-up display, holographic projector, etc.) to control system 110 for facilitating user output (e.g., simulation of a weld) when desired. It should be appreciated that various ones of the foregoing functional aspects of control system 110 may be included or omitted, as desired or determined to be appropriate, depending upon the specific implementation of a particular instance of system 100.

User interface and display adapter 706 is configured to be coupled to storage device 108, sensor 109, another device, or a combination thereof. Storage device 108 may include one or more of a hard drive, optical drive, solid state drive, or one or more databases. Storage device 108 may be configured to be coupled to controller 152, processor 101, or memory 102, such as to exchange program code for performing or techniques described here, at least with reference to instructions 103. Storage device 108 may include a random access memory (RAM), a memory buffer, a hard drive, an erasable programmable read-only memory (EPROM), an electrically erasable read-only memory (EEPROM), a read-only memory (ROM), Flash memory, and the like. Storage device 108 may include or correspond to memory 102.

In some implementations, controller 152 may be configured to use a neural network to perform a pixel-wise classification and/or point-wise classification to identify and classify structures within workspace 130.

For example, the pixel-wise classification may use images captured by or based on the images captured by sensor 109 and the point-wise classification may use one or more point clouds. To illustrate, controller 152, upon execution of instructions 103 or executable code 113, may use a neural network to perform the pixel-wise classification and/or the point-wise classification to identify and classify structures within workspace 130. For example, controller 152 may perform the pixel-wise classification and/or the point-wise classification to identify one or more imaged structures within workspace 130 as a part (e.g., 135 or 136), as a seam on the part or at an interface between multiple parts (referred to herein collectively as a candidate seam), as fixture 127, as robot 120, etc.

In some implementations, controller 152 may identify and classify pixels and/or points based on a neural network (e.g., a U-net model) trained using appropriate training data. For example, the neural network can be trained on image data, point cloud data, spatial information data, or a combination thereof. In some implementations, the point cloud and/or the image data may include information captured from various vantage points within workspace 130 and the neural network can be operable to classify fixture (e.g., 127) or a candidate seam on part 135 from multiple angles and/or viewpoints. In some examples, the neural network can be trained to operate on a set of points directly (e.g., the neural network includes a dynamic graph convolutional neural network) and the neural network may be implemented to analyze unorganized points on the point cloud. In some examples, a first neural network can be trained on point cloud data to perform the point-wise classification and a second neural network can be trained on image data to perform the pixel-wise classification. The first neural network and the second neural network can individually identify one or more candidate seams and localize the one or more candidate seams. The output from the first neural network and the second neural network can be combined as a final output to determine the location and orientation of the one or more candidate seams on part 135.

In some examples, if pixel-wise classification is performed, one or more results can be projected onto 3D point cloud data and/or a meshed version of the point cloud data, thereby providing information on a location of fixture 127 in workspace 130. If the input data is image data (e.g., color images), spatial information such as depth information may be included along with color data in order to perform pixel-wise segmentation. In some examples, pixel-wise classification can be performed to identify a candidate seam and localize the candidate seam relative to a part (e.g., 135 or 136).

In some implementations, controller 152 may identify and classify pixels and/or points as specific structures within workspace 130. For example, controller may identify and classify pixels or points as fixtures 127, a part (e.g., 135 or 136), a candidate seam of the part, etc.

Portions of the image and/or point cloud data classified as non-part and non-candidate seam structures, such as fixture 127, may be segmented out (e.g., redacted or otherwise removed) from the data, thereby isolating data identified and classified as corresponding to the part and/or the candidate seam associated with the part. In some examples, after identifying the candidate seam and segmenting the non-part and non-candidate seam data (or, optionally, prior to such segmentation), the neural network can be configured to analyze each candidate seam to determine a type of seam. For example, the neural network can be configured to determine whether the candidate seam is a butt joint, a corner joint, an edge joint, a lap joint, a tee joint, or the like. The model (e.g., a U-net model) may classify the type of seam based on data captured from multiple vantage points within workspace 130.

If pixel-wise classification is performed using image data, controller 152 may project the pixels of interest (e.g., pixels representing one or more parts and one or more candidate seams associated with the one or more parts onto a 3D space to generate a set of 3D points representing the parts and the candidate seams. Additionally, or alternatively, if point-wise classification is performed using point cloud data, the points of interest may already exist in 3D space in the point cloud. In either case, from the perspective of controller 152, the 3D points may be an unordered set of points and at least some of the 3D points may be clumped or clustered together. To eliminate such noise and generate a continuous and contiguous subset of points to represent a candidate seam, a Manifold Blurring and Mean Shift (MBMS) technique or similar techniques may be applied. Such techniques may condense the points and eliminate noise. Subsequently, controller 152 may apply a clustering method to break down one or more candidate seams into individual candidate seams. Stated another way, instead of having several subsets of points representing multiple candidate seams, clustering can break down each subset of points into individual candidate seams. Following clustering, controller 152 may fit a spline to each individual subset of points. Accordingly, each individual subset of points can be an individual candidate seam.

In some implementations, controller 152 receives image data captured by sensor 109 from various locations and vantage points within workspace 130. Controller 152 may produce a set of candidate seams associated with one or more parts (e.g., 135 or 136) that indicate locations and orientations of those candidate seams. For example, controller 152 performs a pixel-wise classification and/or point-wise classification technique using a neural network to classify and identify each pixel and/or point as a part (e.g., 135 or 136), a candidate seam on or associated with the part or at an interface between multiple parts, fixture 127, etc. Structures identified as being non-part structures and non-candidate seam structures are segmented out, and controller 152 may perform additional processing on the remaining points (e.g., to mitigate noise). After the set of candidate seams is produced, controller 152 may determine whether the candidate seams are actually seams and may optionally perform additional processing using a priori information, such as CAD models of the parts and seams. The resulting data is suitable for use by controller 152 to plan a path for laying weld along the identified seams.

In some implementations, an identified candidate seams may not be seams (e.g., the identified candidate seam may be false positives). To determine whether the identified candidate seam is an actual seams, controller 152 may determine a confidence value based on information from sensor 109. For example, controller 152 may use the images captured by sensor 109 from various vantage points inside workspace 130 to determine the confidence value. The confidence value represents a likelihood of whether or not the candidate seam determined from the corresponding vantage point is an actual seam. Controller 152 may then compare the confidence values for the different vantage points and eliminate candidate seams that are unlikely to be actual seams. For example, controller 152 may determine a mean, median, maximum, or any other suitable summary statistic of the candidate values associated with a specific candidate seam. Generally, a candidate seam that corresponds to an actual seam will have consistently high (e.g., greater than or equal to a threshold) confidence values across the various vantage points used to capture that candidate seam. If the summary statistic of the confidence values for a candidate seam is greater than or equal to a threshold value, controller 152 can designate the candidate seam as an actual seam. Conversely, if the summary statistic of the confidence values for a candidate seam is less than a threshold value, the candidate seam can be designated as a false positive that is not eligible for welding.

After identifying a candidate seam that is an actual seam, controller 152 may perform additional processing referred to herein as registration. An illustrative example of registration is described further herein at least with reference to FIG. 12. In some implementations, controller may perform registration using a priori information, such as a CAD model (or a point cloud version of the CAD model). For example, there may exist a difference between seam dimensions associated with a part (e.g., 135 or 136) and seam dimensions in the CAD model. In some implementations, the CAD model (or a copy of the CAD model) may be deformed (e.g., updated) to account for any such differences. It is noted that the updated CAD model may be used to perform path planning. Accordingly, controller 152 may compare a first seam (e.g., a candidate seam on a part that has been verified as an actual seam) to a second seam (e.g., a seam annotated on the CAD model corresponding to the first seam) to determine differences between the first and second seams. In some implementations, the seam annotated on the CAD model may have been annotated by an operator/user. The first seam and the second seam can be in nearly the same location, in instances in which the CAD model and/or controller 152 accurately predicts the location of the candidate seam. Alternatively, the first seam and the second seam can partially overlap, in instances in which the CAD model and/or controller 152 is partially accurate. Controller 152 may perform a comparison of the first seam and the second seam. This comparison of the first seam and the second seam can be based in part on shape and relative location in space of both the seams. Should the first seam and the second seam be relatively similar in shape and be proximal to each other, the second seam can be identified as being the same as the first seam. In this way, controller 152 can account for the topography of the surfaces on the part that are not accurately represented in the CAD models. In this manner, controller 152 can identify candidate seams and can sub-select or refine or update candidate seams relative to the part using a CAD model of the part. Each candidate seam can be a set of updated points that represents the position and orientation of the candidate seam relative to the part.

Referring to FIG. 12, FIG. 12 is a block diagram illustrating a registration process flow 1200 according to one or more aspects. Some or all steps of the registration process flow 1200 may be performed by controller 152. For example, controller 152 may instructions 103 or executable code 113 to perform at least a portion or an entirety of registration process flow 1200.

Controller 152 may perform a coarse registration 1202 using a point cloud 1204 of a CAD model and a scan point cloud 1206 formed using images captured by sensor 109. Point cloud 1204 of the CAD model and scan point cloud 1206 may include or correspond to point cloud 169. The CAD model may include or correspond to design 770. The CAD model point cloud 1204 and the scan point cloud 1206 may be sampled such that their points have a uniform or approximately uniform dispersion, so that they both have equal or approximately equal point density, or a combination thereof.

In some implementations, controller 152 downsamples point clouds 1204, 1206 by uniformly selecting points in the clouds at random to keep and discarding the remaining, non-selected points. For example, controller 152 may use a Poisson Disk Sampling (PDS) down sampling algorithm to downsample point cloud 1204 or 1206. Controller 152 may provide, as an input to the PDS algorithm, the boundaries of point cloud 204 or 1206, a minimum distance between samples, a limit of samples to choose before they are rejected, or a combination thereof.

In some implementations, a delta network may be used to deform one model to another model during coarse registration 1202. The delta network may be a Siamese network that takes a source model and target model and encodes them into latent vectors. Controller 152 may use the latent vectors to predict per-point deformations that morph or update one model to another. It is noted that the delta network may not require a training dataset. Given the CAD model and scan point clouds 1204, 1206, controller 152 in the context of a Delta network spends one or more epochs learning the degree of dissimilarity or similarity between the two. During these epochs, the Delta network may learn one or more features that are subsequently useful for registration. In some implementations, the Delta network may use skip connections to learn deformation and, in other implementations, skip connections may not be used. In some cases, CAD models include surfaces that are not present in 3D point cloud generated using the captured images (e.g., scans). In such cases, the Delta network moves all points corresponding to the missing surfaces from the CAD model point cloud 1204 to some points in the scan point cloud 1206 (and update the scan point cloud 1206). Accordingly, during registration, controller 152 (e.g., the Delta network) may use learned features and transform (or update) the original CAD model, or it may use the learned features and transform the deformed CAD model.

In some implementations, the delta network may include an encoder network such as a dynamic graph convolutional neural network (DGCNN). After the point clouds are encoded into features, a concatenated vector composed of both CAD and scan embedding may be formed. After implementing a pooling operation (e.g., max pooling), a decoder may be applied to the resultant vector. In some examples, the decoder may include five convolutional layers with certain filters (e.g., 256, 256, 512, 1024, N×3 filters). The resulting output may be concatenated with CAD model and scan embeddings, max pooled, and subsequently provided once more to the decoder. The final results may include per-point transformations.

Irrelevant data and noise in the data (e.g., the output of the coarse registration 1202) may impact registration of part 135 or 136. For at least this reason, it is desirable to remove as much of the irrelevant data and noise as possible. To illustrate, a bounding box 1208 may be used to remove this irrelevant data and noise (e.g., fixture 127) in order to limit the area upon which registration is performed. Stated another way, data inside the bounding box is retained, but all the data, 3D or otherwise, from outside the bounding box is discarded. The aforementioned bounding box may be any shape that can enclose or encapsulate the CAD model itself (e.g., either partially or completely). For instance, the bounding box may be an inflated or scaled-up version of the CAD model. The data outside the bounding box may be removed from the final registration or may still be included but weighted to mitigate its impact.

During refined registration 1210, controller 152 passes the output of the bounding box 1208 as patches through a set of convolutional layers in a neural network that was trained as an autoencoder. More specifically, the data may be passed through the encoder section of the autoencoder, and the decoder section of the autoencoder may not be used. The input data may be the XYZ locations of the points of the patch in the shape, for instance (128, 3). The output may be a vector of length 1024, for example, and this vector is useful for the per-point features.

A set of corresponding points that best support the rigid transformation between the CAD point cloud and scan point cloud models should be determined during registration. Corresponding candidates may be stored (e.g., in database 112) as a matrix in which each element stores the confidence or the probability of a match between two points:

$$P = {[ \begin{matrix}{p}_{00} & {p}_{01} & . & . & . & {p}_{0 n} \\ . & . & . & . & . & . \\ . & . & . & . & . & . \\ . & . & . & . & . & . \\ . & . & . & . & . & . \\ {p}_{m 0} & {p}_{m 1} & . & . & . & {p}_{mn}\end{matrix} ]}_{[ {m}_{source} , {n}_{target} ]}$$

Controller 152 may use a variety of techniques to find corresponding points based on this matrix. For example, the techniques may include hard correspondence, soft correspondence, product manifold filter, graph clique, covariance, etc. After completion of the refined registration 1210, the registration process 1200 is completed at 212.

In some implementations, the actual location of a seam may differ from the seam location as determined by controller 152 using sensor imaging (e.g., using scan point clouds) and/or as determined by a CAD model (e.g., using CAD model point clouds). In such cases, a scanning procedure (also sometimes referred herein as pre-scan) may be implemented to correct the determined seam location to more closely or exactly match the actual seam location, such as a location on a part (e.g., 135 or 136). In the scanning procedure, sensor 109 that is positioned on robot 120 (referred to herein as an on-board sensor) is configured to perform a scan of the seam, such as seam 144. In some instances, this scan may be performed using an initial motion and/or path plan generated by controller 152 based on the CAD model, the scan, or a combination thereof. For example, sensor 109 may scan any or all areas of workspace 130. During the initial motion and/or path plan, sensor 109 may capture observational images and/or data. The observational images and/or data may be processed by controller 152 to generate seam point cloud data. Controller 152 may use the seam point cloud data when processing the point cloud(s) 1204 and/or 1206 to correct the seam location. Controller 152 may also use seam point cloud data in correcting path and motion planning.

In some examples, the registration techniques described with reference to registration process flow 1200 may be useful to compare and match a seam identified by the on-board sensor 109 with a seam determined using a sensor other than the onboard sensor 109. By matching the seams in this manner, robot 120 (and, more specifically, the head of robot 120) is positioned relative to the actual seam as desired.

In some examples, the pre-scan trajectory of robot 120 may be identical to that planned for welding along a seam. In some such examples, the motion taken for robot 120 during pre-scan may be generated separately so as to limit the probability or curtail the instance of collision, to better visualize the seam or key geometry with the onboard sensor (e.g., 109), or to scan geometry around the seam in question. In some such implementations, the pre-scan trajectory is determined based on the CAD model, a multipass weld plan, or a combination thereof.

In some examples, the pre-scan technique may include scanning more than a particular seam or seams, and rather may also include scanning of other geometry of one or more parts (e.g., 135 or 136). The scan data may be useful for more accurate application of any or all of the techniques described herein (e.g., registration techniques) to find, locate, detect a seam and ensure the head of robot 120 will be placed and moved along the seam as desired.

In some examples, the scanning technique (e.g., scanning the actual seam using sensors/cameras mounted on the weld arm/weld head) may be useful to identify gap variability information about a seam rather than position and orientation information about the seam. For example, the scan images captured by sensor 109 on robot 120 during a scanning procedure may be used to identify variability in one or more gaps and adjust a welding trajectory or path plan to account for such gaps. For example, 3D points, 2D image pixels, or a combination thereof, may be useful to locate a variable gap between one or more parts to be welded. To illustrate, a gap between parts to be welded together may be located, identified and measured to determine a size of the gap. In tack weld finding or general weld finding, former welds or material deposits in gaps between parts to be welded may be identified using 3D points and/or 2D image pixels. Any or all such techniques may be useful to optimize welding, including path planning. In some instances, the variability in gaps may be identified within the 3D point cloud generated using the images captured by sensor 109. In yet other instances, the variability in gaps may be identified based on or using a scanning technique (e.g., scanning the actual seam using sensors/cameras mounted on the weld arm/weld head) performed while performing a welding operation on the task. In any one of the instances, controller 152 may be configured to adapt one or more welding instructions dynamically (e.g., welding voltage) based on the determined location and size of the gap. For example, the dynamically adjusted welding instructions for the welding robots can result in precise welding of seam at variable gaps. Adjusting welding instructions may include adjusting a welder voltage, a welder current, a duration of an electrical pulse, a shape of an electrical pulse, a material feed rate, or a combination thereof.

In some implementations, user interface and display adapter 706 can provide the user with an option to view candidate seams. For example, user interface and display adapter 706 may provide a graphical representation of a part and/or candidate seams on the part. Additionally, or alternatively, user interface and display adapter 706 may group or present the candidate seam based on the type of seam. To illustrate, controller 152 can identify the type of seam which can be presented to a user via user interface and display adapter 706. For instance, candidate seams identified as lap joints can be grouped under a label “lap joints” and can be presented to the user via user interface and display adapter 706 under the label “lap joints.” Similarly, candidate seams identified as edge joints can be grouped under a label “edge joints” and can be presented to the user via user interface and display adapter 706 under the label “edge joints.”

User interface and display adapter 706 can further provide the user with an option to select a candidate seam to be welded by robot 120. For example, each candidate seam on a part can be presented as a selectable option (e.g., a press button) on user interface and display adapter 706. When the user selects a specific candidate seam, the selection can be sent to controller 152. Controller 152 can generate instructions for robot 120 to perform welding operations on that specific candidate seam.

In some examples, the user can be provided with an option to update welding parameters. For example, user interface and display adapter 706 can provide the user with a list of different welding parameters. The user can select a specific parameter to be updated. Changes to the selected parameter can be made using a drop-down menu, via text input, etc. This update can be transmitted to controller 152 so that controller 152 can update the instructions for robot 120.

In examples for which the system 100 is not provided with a priori information (e.g., a CAD model) of a part (e.g., 135 or 136), sensor 109 can scan the part. A representation of the part can be presented to the user via user interface and display adapter 706. This representation of the part can be a point cloud and/or a mesh of the point cloud that includes projected 3D data of the scanned image of the part obtained from sensor 109. The user can annotate one or more seams that are to be welded in the representation via user interface and display adapter 706. Alternatively, controller 152 can identify candidate seams in the representation of the part and can be presented to the user via user interface and display adapter 706. The user can select seams that are to be welded from the candidate seams. User interface and display adapter 706 can annotate the representation based on the user's selection. In some implementations, the annotated representation can be saved in database 112.

After one or more seams on the part have been identified, controller 152 may plan a path for robot 120 for a subsequent welding process. In some examples, graph-matching and/or graph-search techniques may be useful to plan a path for robot 120. A particular seam identified as described above may include multiple points, and the path planning technique entails determining a different state of robot 120 for each such point along a given seam. A state of robot 120 may include, for example, a position of robot 120 within workspace 130 and a specific configuration of the arm of robot 120 in any number of degrees of freedom that may apply. For instance, for robot 120 that has an arm having six degrees of freedom, a state for robot 120 would include not only the location of robot 120 in workspace 130 (e.g., the location of the weld head of robot 120 in three-dimensional, x-y-z space), but it would also include a specific substate for each of the robot arm's six degrees of freedom. Furthermore, when robot 120 transitions from a first state to a second state, it may change its location within workspace 130, and in such a case, robot 120 necessarily would traverse a specific path within workspace 130 (e.g., along a seam being welded). Thus, specifying a series of states of robot 120 necessarily entails specifying the path along which robot 120 will travel within workspace 130. Controller 152 may perform the pre-scan technique or a variation thereof after path planning is complete, and controller 152 may use the information captured during the pre-scan technique to make any of a variety of suitable adjustments (e.g., adjustment of the X-Y-Z axes or coordinate system used to perform the actual welding along the seam).

In some implementations, controller 152 may be configured to determine one or more dimensions of a seam (e.g., 144). For example, controller 152 may determine the one or more dimensions of the seam based on sensor data 180 from sensor 109 or point cloud 169. The one or more dimension may include a depth of the seam, a width of the seam, a length of the seam, or a combination thereof. Additionally, or alternatively, controller 152 may determine how the one or more dimensions vary along a length of the seam. In some implementations, controller 152 may determine gap variability information, such as the one or more dimensions of the seam, how the one or more dimensions of the seam vary over a length of the seam, or a combination thereof. Controller 152 may determine control information 182 based on the gap variability information. For example, controller may generate or update control information 182, such as movement of robot 120 or one or more welding parameters, based on the gap variability information. In some implementations, to generate or update the control information, controller 152 may compare the gap variability information with design 770, waypoints 772, weld profile 774, weld fill plan 775, weld instructions 176, or a combination thereof.

In some implementations, robot 120 may be configured to autonomously weld over seam 144 having one or more varying dimensions, such as a varying widths. As such, in addition to identifying position and orientation information about seam 144, one or more scanning techniques described herein (e.g., scanning the actual seam using sensors/cameras mounted on the weld arm/weld head, or scanning the part from sensors/cameras positioned somewhere in the workspace and identifying the seam) may be implemented to identify gap variability information about the seam. Identifying the gap variability information may include determining a gap width along the length of the seam or determining the gap profile along the length of the seam (e.g., how the gap along the seam varies). Based on the determined gap variability information, controller 152 may generate or update waypoints 772 (e.g., waypoint information) or trajectory information associated with waypoints 772. Updating trajectory information associated with waypoints 772 may include generating or updating, based on the gap variability information, control information 182, such as the welding parameter and the motion parameters of robot 120 at each waypoint. For example, at each waypoint where a dimension is greater than or equal to an average gap dimension of seam 144 or a tolerance of seam 144, the welding and/or motion parameters of robot 120 may be generated/updated (e.g., the voltage/current may be increased) to fuse/deposit more or less metal at the waypoint.

In some implementations, identification of the variable gap information may include or correspond to determining the seam position and orientation, such as seam position information, seam orientation information, or a combination thereof. After determining the seam position or orientation, controller 152 may detect one or more edges that form or define the seam. For example, controller 152 may use an edge detection technique, such as Canny detection, Kovalevsky detection, another first-order approach, or a second-order approach, to detect the one or more edges. In some implementations, controller 152 may use a supervised or self-supervised neural network to detect the one or more edges. The detected edges may be used to determine a variability in the gap (e.g., one or more dimensions) along the length of the seam. In some instances, the variability in gaps may be identified within or based on the 3D point cloud (e.g., point cloud 169) generated using the images captured by sensor 109. In some other instances, the variability in gaps may be identified using a scanning technique (e.g., scanning the actual seam using sensors/cameras mounted on the weld arm/weld head) performed while performing a welding operation on the seam.

In some implementations, the variable gap information determined using one or more variable gap identification techniques may be used to optimize one or more operations associated with welding of the seam, including path planning. For example, controller 152 may be configured to generate or adapt the welding instructions and/or motion parameters dynamically (e.g., welding voltage) based on the width/size of the gap. For example, the dynamically adjusted welding instructions for robot 120 can result in precise welding of the seam at variable gaps. Adjusting the welding instructions, such as weld instruction 176, may include adjusting a welder voltage, a welder current, a duration of an electrical pulse, a shape of an electrical pulse, a material feed rate, or a combination thereof. Additionally, or alternatively, adjusting motion parameters may include adjusting motion of weld head to include different weaving patterns, such as convex weave, concave weave, etc. to weld a seam having the variable gap.

In some implementations, controller 152 may instruct or control sensor 109 to generate information associated with seam 144. For example, controller 152 may instruct or control sensor 109 to capture one or more images associated with seam 144. Controller 152 may receive the information associated with seam 144 and may process the information. For example, controller 152 may use a neural network to perform a segmentation operation that remove non-seam information from the information. In some implementations, controller 152 may process the information based on design 770, such as a CAD model. The design 770 may include annotated data.

In some implementations, controller 152 may identify seam 144 based on the information. Additionally, or alternatively, controller may localize seam 144 based on the information. To illustrate, controller 152 may perform seam recognition to identify pixel locations in multiple images and my triangulate the pixels corresponding to seam 144 that fit within an epipolar constraint. In some implementations, controller 152 may determine one or more offsets of the information (from sensor 109) as compared to design 770.

In some implementations, controller 152 is configured to generate weld instructions 176 for welding along seam 144. For example, welding instructions 176 may be associated with welding that is performed in a single pass, i.e., a single pass of welding is performed along seam 144, or welding that is performed in multiple passes. In some implementations, controller 152 may be configured to enable multipass welding, which is a welding technique robot 120 uses to make multiple passes over seam 144. For example, controller 152 may be configured for Multi-Pass Adaptive Fill (MPAF), which is a framework for determining an optimal number of weld passes and the subsequent weld parameters to fill a weld joint. The weld joint can have volumetric variation and the weld parameters will adapt to produce the appropriate level of fill.

To enable multipass welding at robot 120, controller 152 may identify seam 144 to be welded and one or more characteristics of seam 144. For example, controller 152 may identify seam 144 based on design 770, the scan data, or a combination thereof. The one or more characteristics of seam 144 may include a height of seam 144, a width of seam 144, a length of seam 144, a volume of seam 144. Additionally, or alternatively, the one or more characteristics of seam 144 may be associated with a weld joint to be formed in seam 144. For example, the one or more characteristics may include a height of the weld joint, a first leg length (S1) of the weld joint, a second leg length (S2) of the weld joint, a capping surface profile of the weld joint, a joint type, or a combination thereof.

To enable multipass welding at robot 120, controller 152 may also determine a fill plan and, optionally, optimize the fill plan. In some implementations, the fill plan may indicate a number of weld layers to fill out the weld joint, a number of target beads to be deposited to fill out the weld joint, one or more target bead profiles, or a combination thereof. The fill plan may be optimized to determine a minimum number of layers, a minimum number of target beads, or a combination thereof. Controller 152 may also generate the fill plan. Generation of the fill plan may include determining or indicating one or more welding parameters for each pass (e.g., each bead) of the fill plan. In some implementations, the one or more welding parameters for a pass may indicate a value of the one or more welding parameters at each of multiple waypoints 772 associated with seam 144. After the fill plan is generated, controller 152 may generate welding instructions 176 based on the fill plan. Additionally, or alternatively, controller 152 may generate control information 182 based on welding instructions 176. Controller 152 may transmit weld instructions 176, control information 182, or a combination thereof to robot 120.

In some implementations, to enable multipass welding, controller 152 may receive or generate sensor data 180, seam pose information, seam feature information, one or more transformation, joint geometry information, or a combination thereof. Sensor data 180 (or information 164) may include a mesh from a scan performed by sensor 109. The seam pose information may include or correspond to point cloud 169 or information 164 (e.g., sensor data 165 or pose information 166). In some implementations, the seam pose information may include information based on a registration, such as a registration process described at least with reference to FIG. 12. In some implementations, the registration process may be a deformed registration process that includes identifying an expected position and expected orientation of a candidate seam on a part (e.g., 135 or 136) to be welded based on design 770 (e.g., a Computer Aided Design (CAD) model of the part). The deformed registration process may also include scanning workspace 130 containing the part to produce point cloud 169 or CAD point cloud 1204 (e.g., a representation of the part), and identifying the candidate seam on the part based on the representation of the part and the expected position and expected orientation of the candidate seam.

The seam feature information may include or indicate one or more seam features determined based on a seam segmentation process. The seam segmentation process may include converting annotated features (of design 770) into a series of waypoints 772 and normal information. For example, the seam segmentation process may use a mesh of a part as an input and output a set of waypoint and surface normal information that represents a feature in an appropriate way for planning. In some implementations, the seam feature information may include or indicate an S1 direction (e.g., a vector at a waypoint that indicates a first surface tangent), an S2 direction (e.g., a vector at the waypoint that indicates a second surface tangent), a travel direction (e.g., of a weld head and that is normal to a plane associated with a weld profile that passes through the waypoint, such as a slice mesh at the waypoint), as illustrative, non-limiting examples. Additionally, or alternatively, the seam information may be used or applied to a local coordinate frame associated with seam 144 and to a global frame associated with workspace 130 to enable controller 152 to determine a global transformation of a gravity vector.

The one or more transformation may include or indicate, or one or more waypoints, a transformation of the part to a real world frame of reference. For example, controller 152 may transform each point of a feature (and corresponding normals) of a part into the real world frame of reference.

The joint geometry information may include or indicate a bevel angle, a root gap size, a wall thickness, a number of sides, a radius of a shaft, a shape (e.g., circular or faceted), or a combination thereof, as illustrate, non-limiting examples. In some implementations, the joint geometry information may be determined based on design 770, such as annotated information included in design 770, or based on a point cloud of the part. Additionally, or alternatively, the joint geometry information may include or correspond to point cloud 169, design 770 (e.g., a CAD model), joint model information 771, or a combination thereof. For example, the joint geometry information may include a joint template that is generated based on point cloud 169, design 770 (e.g., a CAD model), joint model information 771, or a combination thereof.

As described with reference to FIG. 7, the present disclosure provides techniques for supporting an optical system. The techniques described enable a system to accurately scan and image a reflective object (e.g., 135 or 136) to allow for accurate generation of a digital representation (e.g., point cloud 169) of the objects. The digital representation may then be relied on for performing additional operations, such as one or more operations associated with welding.

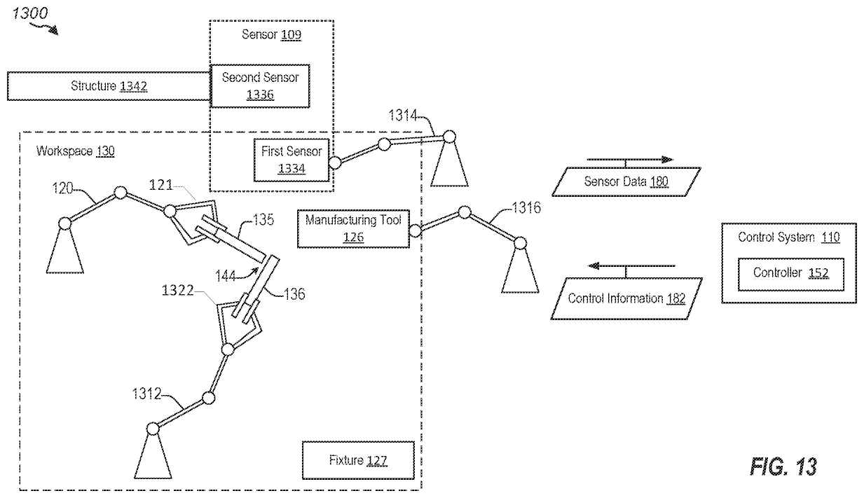

Referring to FIG. 13, FIG. 13 is a block diagram illustrating another system 1300 configured to implement an optical system according to one or more aspects. System 1300 may include or correspond to system 100 of FIG. 1 or system 700 of FIG. 7.

As compared to system 100 of FIG. 1 or system 700 of FIG. 7, system 1300 includes multiple robots. To illustrate, the multiple robot include four robots including a first robot (e.g., 120), a second robot 1312, a third robot 1314, and a fourth robot 1316. Additionally, sensor 109 includes multiple sensors, such as a first sensor 1334 and a second sensor 1336. System 1300 also includes a structure 1342, and a second tool 1322 in addition to a first tool (e.g., 121).

Workspace 130 of system 1300 may include one or more devices or components of system 1300. As shown, workspace 130 includes first robot 120, first tool 121, second robot 1312, second tool 1322, first sensor 1334, and manufacturing tool 126. In other implementations, workspace 130 may include fewer or more components or devices than shown in FIG. 13. For example, workspace 130 may include third robot 1314, fourth robot 1316, second sensor 1336, structure 1342, control system 110, or a combination thereof.

In some implementations, the multiple robot devices may include or correspond to robot 120. For example, at least one of the multiple robot devices (e.g., 120, 1312, 1314, 1316) may include a robotic arm providing—as a non-limiting example—six-degrees of freedom. In implementations, the robotic arm may be manufactured by YASKAWA®, ABB® IRB, KUKA®, Universal Robots®. Additionally, or alternatively, the robotic arm may be configured to be coupled to one or more tools.

Second robot 1312 may include a second robotic arm. Second tool 1322 may be coupled to an end of the second robotic arm. In some implementations, second tool 322 may include or correspond to first tool 121. For example, second tool 1322 may be configured to be selectively coupled to a second set of one or more objects that include second part 136. The second set of one or more objects may be the same as or different from the first set of objects first tool 121 is configured to be coupled to.

Third robot 1314 may include a third robotic arm. First sensor 1334 may be coupled to an end of the third robotic arm. In some implementations, first sensor 1334 is configured to generate first sensor data (e.g., 180). For example, first sensor 1334 is configured to capture one or more images of first part 135, the second part 136, or a combination there. Fourth robot 1316 includes a fourth robotic arm. Manufacturing tool 126 (e.g., a welding tool) is coupled to an end of the fourth robotic arm.

Second sensor 1336 is configured to generate second sensor data (e.g., 180). For example, second sensor 1336 is configured to capture one or more images of first part 135, second part 136, or a combination there. In some implementations, second sensor 1336 is positioned on or coupled to structure 1342. Structure 1342, such as a frame or weldment, may be dynamic or static. In either dynamic or static configuration of structure 1342, second sensor 1336 may be configured to be dynamic or static with respect to structure 1342—e.g., if second sensor 1336 is dynamic, the second sensor may be configured to rotate (e.g., pan) or tilt.

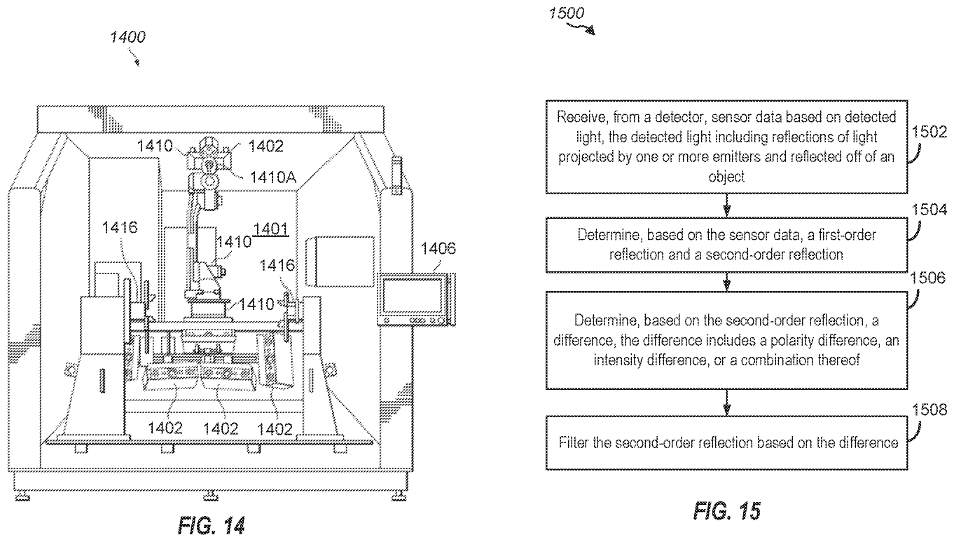

Referring now to FIG. 14, FIG. 14 is a schematic diagram of an autonomous robotic welding system 1400 according to one or more aspects. System 1400 may include or correspond to system 100, system 700, or system 1300.

System 1400 includes a workspace 1401. Workspace 1401 may include or correspond to workspace 130. In some implementations, workspace 1401 includes one or more sensors 1402, a robot 1410, and one or more fixtures 1416. The one or more sensors 1402 may include or correspond to sensor 109, scanner 192, optical element 198, emitter 205, detector 210, a camera, first sensor 1334, or second sensor 1336. In some implementations, one or more sensors 1402 may include a movable sensor. For example, at least one sensor of one or more sensors 1402 may be coupled to or included in robot 1410. Robot 1410 may include or correspond to robot 120, 1312, 1314, or 1316. The one or more FIG. 416 may include or correspond to fixture 127. System 400 may also include a UI 406 coupled to workspace 1401. UI 1406 may include or correspond to UI and display adapter 706. Although workspace 1401 is described as including one or more sensors 1402, robot 1410, and one or more fixtures 1416, in other implementations, workspace 1401 may optionally include or not include one or more of sensors 1402, robot 1410, or fixtures 1416. Additionally, or alternatively, system 1400 may include one or more additional components, such as a control system 110 or components thereof.

Robot 1410 may include multiple joints and members (e.g., shoulder, arm, elbow, etc.) that enable robot 1410 to move in any suitable number of degrees of freedom. Additionally, or alternatively, robot 410 includes a weld head 1410A that performs welding operations on a part. For example, the part (e.g., 135, 136, 1002, 1004, 1102, or 1104) may be supported by fixture 1416, such as a clamps.

During operation of system 1400, the one or more sensors 1402 capture one or more images of workspace 1401. In some implementations, the one or more images include image data. One or more sensors 1402 may provide the one or more images a controller (not shown in FIG. 14). For example, the controller may include or correspond to controller 152. The controller may generate one or more 3D representations (e.g., one or more point clouds) of workspace 1401. For example, the one or more point clouds may include or correspond to one or more fixtures 1416, a part supported by one or more fixtures 1416, and/or other structures within workspace 401. The controller may identify, based on the 3D representations, to identify a seam, such as seam 144. For example, the seam may include or correspond to a part (e.g., 135 or 136) the is supported by one or more fixtures 1416. Additionally, or alternatively, the controller may plan, based on the 3D representation, a path for welding the seam without robot 1410 colliding with structures within workspace 1401, and to control robot 1410 to weld the seam.

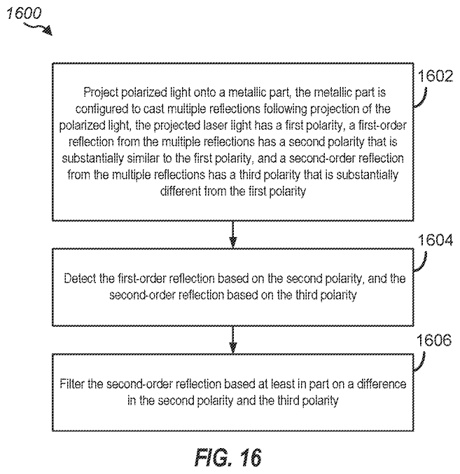

Referring now to FIG. 15, FIG. 15 is a flow diagram illustrating an example process 1500 to implement an optical system according to one or more aspects. Operations of process 1500 may be performed by a control system or a controller (referred to collectively as “the controller” with reference to FIG. 15), such as control system 110, controller 152, or processor 101. Additionally, or alternatively, the controller may be configured to control or included in system 100, system 700, system 1300, or system 1400. For example, example operations (also referred to as “blocks”) of process 1500 may enable a controller to implement an optical system.

In block 1502, the controller receives, from a detector, sensor data based on detected light, the detected light including reflections of light projected by one or more emitters and reflected off of an object. For example, the detector may include or correspond to sensor 109, scanner 192, detector 210, or a combination thereof. The sensor data may include or correspond to sensor data 180, sensor data 165, image data 153, polarity information 154, intensity information 155, angle information 157, or filtered image data 156. In some implementations, the sensor data includes image data, such as one or more images. The one or more emitters may include or correspond to sensor 109, scanner 192, optical element 198, emitter 205, first laser 510, second laser 512, retarder 520, beam splitter 522, Powell lens 524, mirror 526, or a combination thereof. The light projected from the one or more emitters may include or correspond to light 215, as an illustrative, non-limiting example. In some implementations, the one or more emitters include a first laser source configured to project first light having a first polarity, a second laser source configured to project second light having a second polarity, or a combination thereof. The first light may include polarized light—e.g., having a first polarity. The object may include or correspond to part 135 or 136. In some implementations, the object includes a metallic object.

In block 1504, the controller determines, based on the sensor data, a first-order reflection and a second-order reflection. The first-order reflection may include or correspond to first-order reflection 225 or 245. The second-order reflection may include or correspond to second-order reflection 255 or 265.

In block 1506, the controller determines, based on the second-order reflection, a difference, the difference includes a polarity difference, an intensity difference, or a combination thereof. For example, the difference may include or correspond to polarity information 154, intensity information 155, or angle information 157.

In block 1508, the controller filters the second-order reflection based on the difference. In some implementations, the filtered second-order reflection may include or correspond to filtered image data 156.

In some implementations, the controller is further configured to transmit, to a scanner, an instruction to perform a scan operation. For example, the scanner may include or correspond to sensor 109 or scanner 192. The scanner may include the one or more emitters, the detector, or a combination thereof. The instruction may include or correspond to control information 182. In some implementations, the instruction indicates a first polarity of the light to be projected by the one or more emitters. Additionally, or alternatively, the controller may generate a digital representation of the object based on the first-order reflection and the filtered second-order reflection. For example, the digital representation of the object may include or correspond to point cloud 169, 500, or 600.

In some implementations, multiple reflections of the light are cast by the object based on the first light. The multiple reflections may include the first-order reflection, the second-order reflection, or a combination thereof. The first order reflection of the multiple reflections may have a second polarity. In some implementations, the second polarity is similar to the first polarity. The second order reflection of the multiple reflections may have a third polarity that is different from the second polarity. In some implementations, the detector is configured to detect the first-order reflection based on the second polarity. Additionally, or alternatively, the detector may detect the second-order reflection based on the third polarity. In some implementations, the difference includes the polarity difference (e.g., 154) based on the second polarity and the third polarity. The detector may generate the sensor data based on the first-order reflection and the second order reflection.

In some implementations, the difference includes the intensity difference (e.g., 155) is based on a first intensity associated with the first-order reflection and a second intensity associated with the second-order reflection. Additionally, or alternatively, the difference may include an angle of linear polarization difference (e.g., 157) based on a first angle of linear polarization associated with the first-order reflection and a second angle of linear polarization associated with the second-order reflection.

In some implementations, the one or more emitters include the first laser configured to project the first light having the first polarity and the second laser source configured to project second light having a second polarity. The second light may be polarized light. The second polarity may be orthogonal to the first polarity. In some implementations, an optical element is configured to receive the first polarized light and transmit a first laser line, based on the first polarized light, to a location on the object. Additionally, or alternatively, the optical element may be configured to receive the second polarized light and transmit a second laser line, based on the second polarized light, to the location on the object. Additionally, or alternatively, the detector may include a camera having an optical filter coupled to the camera. The optical filter may be configured to pass through more light having the first polarity than the second polarity. Additionally, in some implementations, the second-order reflection includes a second-order reflection associated with the first light (e.g., the first laser line) and that has a polarity that is different from the first polarity of the first light, and a second-order reflection associated with the second light (e.g., the second laser line) and that has a polarity that is different from the second polarity of the second light.

In some implementations, a scanner includes the first laser source, the second laser source, and the detector. The controller is further configured to transmit, to the scanner, an instruction to perform a scan operation. The scan operation may include transmission of the first polarized light at a first time, or during a first time period, by the first laser source. Additionally, or alternatively, the scan operation may include transmission of the second polarized light at a second time, or during a second time period, by the second laser source. The first time may be a different time from the second time. The first time period may be a different time period from the second time period, such as a non-overlapping time period with the second time period. The scan operation may further include generation of the sensor data based on a second-order reflection of the first polarized light and a second-order reflection of the second polarized light. In some implementations, the second-order reflection of the first polarized light has a first intensity, and the second-order reflection of the second polarized light has a second intensity. The controller may identify the second-order reflection of the first polarized light and the second-order reflection of the second polarized light based on the intensity difference, where the intensity difference is based on the first intensity and the second intensity.

In some implementations, the sensor data includes a first image of the object during reflection of the first light. The controller may be configured to filter the first image based on the identified second-order reflection of the first polarized light, the identified second-order reflection of the second polarized light, or a combination thereof.

Referring now to FIG. 16, FIG. 16 is a flow diagram illustrating an example process 1600 to implement an optical system according to one or more aspects. Operations of process 1600 may be performed by a control system or a controller (referred to collectively as “the controller” with reference to FIG. 16), such as control system 110, controller 152, or processor 101. Additionally, or alternatively, the controller may be configured to control or included in system 100, system 700, system 1300, or system 1400. For example, example operations (also referred to as “blocks”) of process 1600 may enable a controller to implement an optical system.

In block 1602, process 1600 includes projecting polarized light onto a metallic part. For example, sensor 109, scanner 192, optical element 198, emitter 205, first laser 510, second laser 512, retarder 520, beam splitter 522, Powell lens 524, mirror 526, or a combination thereof, may project or transmit the light. In some implementations, a laser source may project the polarized light. The light may include or correspond to light 215, as an illustrative, non-limiting example. The metallic part may include or correspond to part 135 or 136.

In some implementations, the metallic part is configured to cast multiple reflections following projection of the polarized light. The projected laser light may have a first polarity. A first-order reflection from the multiple reflections may have a second polarity that is substantially similar to the first polarity. A second-order reflection from the multiple reflections may have a third polarity that is substantially different from the first polarity. In block 1604, process 1600 also includes detecting the first-order reflection based on the second polarity, and the second-order reflection based on the third polarity. For example, a detector may be configured to detect the first-order reflection and the second order reflection. For example, the detector may include or correspond to sensor 109, scanner 192, detector 210, or a combination thereof.

In block 1606, process 1600 further includes filtering the second-order reflection based at least in part on a difference in the second polarity and the third polarity. For example, the difference may include or correspond to polarity information 154. In some implementations, the filtered second-order reflection may include or correspond to filtered image data 156. In some implementations, filtering the second-order reflection based at least in part on the difference in the second polarity and the third polarity may be performed by the controller

In some implementations, process 1600 may include instructing the laser source to project the polarized light onto the metallic part. Additionally, or alternatively, process 1600 may include instructing the detector to capture an image of the metallic part when the polarized light is projected onto the metallic part. For example, the controller may be configured to instruct the laser source or the detector. In some implementations, the image may include or correspond to sensor data 180, sensor data 165, image data 153, or filtered image data 156

In some implementations, process 1600 includes extracting, from the image of the metallic part, a first sub image corresponding to the first-order reflection. The extraction of the first sub image may be based on or is in accordance with the second polarity. Additionally, or alternatively, process 1600 may include extracting, from the image of the metallic part, a second sub image corresponding to the second-order reflection. Extraction of the second sub image may be based on or is in accordance with the third polarity. For example, the controller may be configured to extract the first sub image, the second sub image, or a combination thereof. In some implementations, the first and second sub images are elements of the image of the metallic part. Additionally, or alternatively, the first and second sub images may include or correspond to sub-images described herein at least with reference to FIG. 4.

In some implementations, the first sub image includes a first intensity information corresponding to the first-order reflection. The first intensity information may be based on or is in accordance with the second polarity. Additionally, or alternatively, the second sub image may include a second intensity information corresponding to the second-order reflection. The second intensity information may be based on is in accordance with the third polarity. In some implementations, process 1600 includes filtering the second-order reflection in accordance with an intensity difference between the first-order reflection and the second-order reflection. For example, the controller may be configured to filter the second-order reflection. The first intensity information, the second intensity information, or the intensity difference may include or correspond to intensity information 155.

In some implementations, process 1600 includes generating a digital representation of the metallic part based on the first-order reflection. The digital representation may include or correspond to point cloud 169. The digital representation may be generated after filtering the second-order reflection. In some implementations, the controller may generate the digital representation.

In some implementations, process 1600 includes detecting a first angle of linear polarization associated with the first-order reflection. Additionally, or alternatively, process 1600 may include detecting a second angle of linear polarization associated with the second-order reflection. In some implementations, the detector may detect the first angle of linear polarization, the second angle of linear polarization, or a combination thereof. In some such implementations, the filtering of the second-order reflection may be based on or performed is in accordance with an angle of linear polarization difference between the first-order reflection and the second-order reflection. The angle of linear polarization difference may include or correspond to angle information 157.

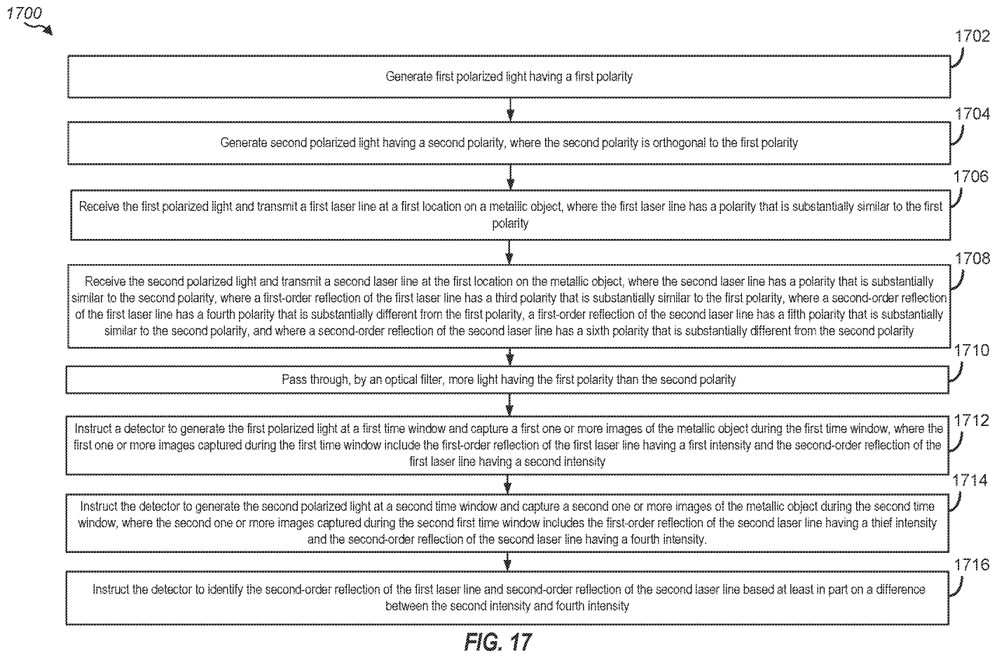

Referring now to FIG. 17, FIG. 17 is a flow diagram illustrating an example process 1700 to implement an optical system according to one or more aspects. Operations of process 1700 may be performed by a control system or a controller (referred to collectively as “the controller” with reference to FIG. 17), such as control system 110, controller 152, or processor 101. Additionally, or alternatively, the controller may be configured to control or included in system 100, system 700, system 1300, or system 1400. For example, example operations (also referred to as “blocks”) of process 1700 may enable a controller to implement an optical system.

In block 1702, process 1700 includes generating first polarized light having a first polarity. The first polarized light may be generated by sensor 109, scanner 192, optical element 198, emitter 205, first laser 510, second laser 512, retarder 520, beam splitter 522, Powell lens 524, mirror 526, or a combination thereof. The first polarized light may include or correspond to light 215 or light generated by first laser 510, as an illustrative, non-limiting example.

In block 1704, process 1700 includes generating second polarized light having a second polarity. The second polarity is orthogonal to the first polarity. The second polarized light may be generated by sensor 109, scanner 192, optical element 198, emitter 205, first laser 510, second laser 512, retarder 520, beam splitter 522, Powell lens 524, mirror 526, or a combination thereof. The first polarized light may include or correspond to light 215 or light generated by second laser 512, as an illustrative, non-limiting example.

In block 1706, process 1700 includes receiving the first polarized light and transmitting a first laser line at a first location on a metallic object. For example, receiving and transmitting may be performed by sensor 109, scanner 192, optical element 198, emitter 205, first laser 510, second laser 512, retarder 520, beam splitter 522, Powell lens 524, mirror 526, or a combination thereof. The first laser line may have a polarity that is substantially similar to the first polarity. The object may include or correspond to part 135 or 136.

In block 1708, process 1700 includes receiving the second polarized light and transmit a second laser line at the first location on the metallic object. For example, receiving and transmitting may be performed by sensor 109, scanner 192, optical element 198, emitter 205, first laser 510, second laser 512, retarder 520, beam splitter 522, Powell lens 524, mirror 526, or a combination thereof.

In some implementations, the second laser line may have a polarity that is substantially similar to the second polarity. A first-order reflection of the first laser line may have a third polarity that is substantially similar to the first polarity. A second-order reflection of the first laser line may have a fourth polarity that is substantially different from the first polarity. A first-order reflection of the second laser line may have a fifth polarity that is substantially similar to the second polarity. A second-order reflection of the second laser line may have a sixth polarity that is substantially different from the second polarity.

In block 1710, process 1700 includes passing through, by an optical filter, more light having the first polarity than the second polarity. In some implementations, a detector includes a camera having the optical filter coupled thereto. For example, the detector may include or correspond to sensor 109, scanner 192, detector 210, or a combination thereof. The optical filter may include one or more optical filters as described herein at least with reference to FIG. 3.

In block 1712, process 1700 includes instructing the detector to generate the first polarized light at a first time window and capture a first one or more images of the metallic object during the first time window. For example, the first one or more images may include or correspond to sensor data, such as sensor data 180, sensor data 165, or image data 153. The first one or more images captured during the first time window include the first-order reflection of the first laser line having a first intensity and the second-order reflection of the first laser line having a second intensity. In some implementations, the controller may instruct the detector.

In block 1714, process 1700 includes instructing the detector to generate the second polarized light at a second time window and capture a second one or more images of the metallic object during the second time window. For example, the second one or more images may include or correspond to sensor data, such as sensor data 180, sensor data 165, or image data 153. The second one or more images captured during the second first time window includes the first-order reflection of the second laser line having a third intensity and the second-order reflection of the second laser line having a fourth intensity. In some implementations, the controller may instruct the detector.

In block 1716, process 1700 includes instructing the detector to identify the second-order reflection of the first laser line and second-order reflection of the second laser line based at least in part on a difference between the second intensity and fourth intensity. For example, the difference between the second intensity and fourth intensity may include or correspond to intensity information 155. In some implementations, the controller may instruct the detector.

In some implementations, process 1700 instructs the detector to filter, from either one of the first or second one or more images, the identified second-order reflection of the first laser line and second-order reflection of the second laser line. For example, the controller may instruct the detector to filter the identified second-order reflection of the first laser line from the first one or more images.

It is noted that one or more blocks (or operations) described with reference to FIGS. 15-17 may be combined with one or more blocks (or operations) described with reference to another of the figures. For example, one or more blocks (or operations) of FIG. 15 may be combined with one or more blocks (or operations) of FIG. 17. As another example, one or more blocks associated with FIG. 15 may be combined with one or more blocks associated with FIG. 17. As another example, one or more blocks associated with FIGS. 15-17 may be combined with one or more blocks (or operations) associated with FIG. 1, 2, 5, 6, 7, 8, 12, 13, or 14. Additionally, or alternatively, one or more operations described above with reference to FIG. 1, 2, 7, 13, or 14 may be combined with one or more operations described with reference to another of FIG. 1, 2, 7, 13, or 14.

Although aspects of the present application and their advantages have been described in detail, it should be understood that various changes, substitutions and alterations can be made herein without departing from the spirit and scope of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding implementations described herein may be utilized. Accordingly, the appended claims are intended to include within their scope such processes, machines, manufacture, compositions of matter, means, methods, or steps.

The above specification provides a complete description of the structure and use of illustrative configurations. Although certain configurations have been described above with a certain degree of particularity, or with reference to one or more individual configurations, those skilled in the art could make numerous alterations to the disclosed configurations without departing from the scope of this disclosure. As such, the various illustrative configurations of the methods and systems are not intended to be limited to the particular forms disclosed. Rather, they include all modifications and alternatives falling within the scope of the claims, and configurations other than the one shown may include some or all of the features of the depicted configurations. For example, elements may be omitted or combined as a unitary structure, connections may be substituted, or both. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one configuration or may relate to several configurations. Accordingly, no single implementation described herein should be construed as limiting and implementations of the disclosure may be suitably combined without departing from the teachings of the disclosure.

While various implementations have been described above, it should be understood that they have been presented by way of example only, and not limitation. Although various implementations have been described as having particular features and/or combinations of components, other implementations are possible having a combination of any features and/or components from any of the examples where appropriate as well as additional features and/or components.

Certain features that are described in this specification in the context of separate implementations also can be implemented in combination in a single implementation. Conversely, various features that are described in the context of a single implementation also can be implemented in multiple implementations separately or in any suitable subcombination. Where methods described above indicate certain events occurring in certain order, the ordering of certain events may be modified. Additionally, certain of the events may be performed concurrently in a parallel process when possible, as well as performed sequentially as described above.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

Those of skill in the art would understand that information, message, and signals may be represented using any of a variety of different technologies and techniques. For example, data, instructions, commands, information, and signals that may be referenced throughout the above description may be represented by voltages, currents, electromagnetic waves, magnetic fields or particles, optical fields or particles, or any combination thereof.

Components, the functional blocks, and the modules described herein with the figures include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. The various illustrative logics, logical blocks, modules, circuits and algorithm processes described in connection with the implementations disclosed herein may be implemented as electronic hardware, computer software, or combinations of both. In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, that is one or more modules of computer program instructions, encoded on a computer storage media for execution by, or to control the operation of, data processing apparatus.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Additionally, the operations of a method or algorithm may reside as one or any combination or set of codes and instructions on a machine readable medium and computer-readable medium, which may be incorporated into a computer program product.

Some implementations described herein relate to methods or processing events. It should be understood that such methods or processing events can be computer-implemented. That is, where a method or other events are described herein, it should be understood that they may be performed by a compute device having a processor and a memory. Methods described herein can be performed locally, for example, at a compute device physically co-located with a robot or local computer/controller associated with the robot and/or remotely, such as on a server and/or in the “cloud.”

Memory of a compute device is also referred to as a non-transitory computer-readable medium, which can include instructions or computer code for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules, Read-Only Memory (ROM), Random-Access Memory (RAM) and/or the like. One or more processors can be communicatively coupled to the memory and operable to execute the code stored on the non-transitory processor-readable medium. Examples of processors include general purpose processors (e.g., CPUs), Graphical Processing Units, Field Programmable Gate Arrays (FPGAs), Application Specific Integrated Circuits (ASICs), Digital Signal Processor (DSPs), Programmable Logic Devices (PLDs), and the like. Examples of computer code include, but are not limited to, micro-code or micro-instructions, machine instructions, such as produced by a compiler, code used to produce a web service, and files containing higher-level instructions that are executed by a computer using an interpreter. To illustrate, examples may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise.

The term “about” as used herein can allow for a degree of variability in a value or range, for example, within 10%, within 5%, or within 1% of a stated value or of a stated limit of a range, and includes the exact stated value or range. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed implementation, the term “substantially” may be substituted with “within [a percentage] of” what is specified, where the percentage includes 0.1, 1, 5, or 10 percent; and the term “approximately” may be substituted with “within 10 percent of” what is specified. The statement “substantially X to Y” has the same meaning as “substantially X to substantially Y,” unless indicated otherwise. Likewise, the statement “substantially X, Y, or substantially Z” has the same meaning as “substantially X, substantially Y, or substantially Z,” unless indicated otherwise. Unless stated otherwise, the word or as used herein is an inclusive or and is interchangeable with “and/or,” such that when “or” is used in a list of two or more items, means that any one of the listed items can be employed by itself, or any combination of two or more of the listed items can be employed. To illustrate, A, B, and/or C includes: A alone, B alone, C alone, a combination of A and B, a combination of A and C, a combination of B and C, or a combination of A, B, and C. Similarly, the phrase “A, B, C, or a combination thereof” or “A, B, C, or any combination thereof” includes: A alone, B alone, C alone, a combination of A and B, a combination of A and C, a combination of B and C, or a combination of A, B, and C.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”). As a result, an apparatus that “comprises,” “has,” “includes,” or “contains” one or more elements possesses those one or more elements, but is not limited to possessing only those one or more elements. Likewise, a method that “comprises,” “has,” “includes,” or “contains” one or more steps possesses those one or more steps, but is not limited to possessing only those one or more steps.

Any implementation of any of the systems, methods, and article of manufacture can consist of or consist essentially of—rather than comprise/have/include—any of the described steps, elements, or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, the term “wherein” may be used interchangeably with “where”.

Further, a device or system that is configured in a certain way is configured in at least that way, but it can also be configured in other ways than those specifically described. The feature or features of one implementation may be applied to other implementations, even though not described or illustrated, unless expressly prohibited by this disclosure or the nature of the implementations.

The claims are not intended to include, and should not be interpreted to include, means-plus- or step-plus-function limitations, unless such a limitation is explicitly recited in a given claim using the phrase(s) “means for” or “step for,” respectively.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure and following claims are not intended to be limited to the examples and designs described herein but is to be accorded the widest scope consistent with the principles and novel features disclosed herein.

1. A system comprising:
a controller configured to:
receive, from a detector, sensor data based on detected light, the detected light including reflections of light projected by one or more emitters and reflected off of an object;
determine, based on the sensor data, a first-order reflection and a second-order reflection;
determine, based on the second-order reflection, a difference, the difference includes a polarity difference, an intensity difference, or a combination thereof; and
filter the second-order reflection based on the difference.

2. The system of claim 1, wherein,
the sensor data includes image data; and
the controller is further configured to:
transmit, to a scanner, an instruction to perform a scan operation, the scanner including the one or more emitters and the detector, where the instruction indicates a first polarity of the light to be projected by the one or more emitters; and
generate a digital representation of the object based on the first-order reflection and the filtered second-order reflection.

3. The system of claim 1, wherein:
the one or more emitters include a first laser source configured to project first light having a first polarity;
the first light includes first polarized light; and
the object includes a metallic object.

4. The system of claim 3, wherein:
multiple reflections of the light are cast by the object based on the first light, the multiple reflections including the first-order reflection and the second-order reflection;
the first-order reflection of the multiple reflections has a second polarity; and
the second-order reflection of the multiple reflections has a third polarity.

5. The system of claim 4, wherein:
the detector is configured to:
detect the first-order reflection based on the second polarity;
detect the second-order reflection based on the third polarity, the third polarity different from the second polarity; and
generate the sensor data based on the first-order reflection and the second-order reflection.

6. The system of claim 4, wherein:
the second polarity is similar to the first polarity; and
the difference includes the polarity difference based on the second polarity and the third polarity.

7. The system of claim 1, wherein:
the difference includes:
the intensity difference is based on a first intensity associated with the first-order reflection and a second intensity associated with the second-order reflection;
an angle of linear polarization difference based on a first angle of linear polarization associated with the first-order reflection and a second angle of linear polarization associated with the second-order reflection; or
a combination thereof.

8. The system of claim 3, wherein:
the one or more emitters include a second laser source configured to project second light having a second polarity, the second polarity is orthogonal to the first polarity; and
the second light includes second polarized light.

9. The system of claim 8, wherein:
the second-order reflection includes:
a second-order reflection associated with the first light and that has a polarity that is different from the first polarity of the first light; and
a second-order reflection associated with the second light and that has a polarity that is different from the second polarity of the second light.

10. The system of claim 8, wherein:
an optical element is configured to:
receive the first polarized light and transmit a first laser line, based on the first polarized light, to a location on the object; and
receive the second polarized light and transmit a second laser line, based on the second polarized light, to the location on the object;
the detector includes a camera having an optical filter coupled to the camera, the optical filter configured to pass through more light having the first polarity than the second polarity; or
a combination thereof.

11. The system of claim 8, wherein:
a scanner includes the first laser source, the second laser source, and the detector; and
the controller is further configured to:
transmit, to a scanner, an instruction to perform a scan operation, the scan operation including:
transmission of the first polarized light at a first time by the first laser source;
transmission of the second polarized light at a second time by the second laser source; and
generation of the sensor data based on a second-order reflection of the first polarized light and a second-order reflection of the second polarized light, where the second-order reflection of the first polarized light has a first intensity, and the second-order reflection of the second polarized light has a second intensity; and
identify the second-order reflection of the first polarized light and the second-order reflection of the second polarized light based on the intensity difference, the intensity difference based on the first intensity and the second intensity.

12. The system of claim 11, wherein:
the sensor data includes a first image of the object during reflection of the first polarized light; and
the controller is configured to filter the first image based on the identified second-order reflection of the first polarized light, the identified second-order reflection of the second polarized light, or a combination thereof.

13. A system comprising:
a laser source configured to project polarized light onto a metallic part, the metallic part to cast multiple reflections following projection of the polarized light, wherein the projected polarized light has a first polarity, wherein a first-order reflection from the multiple reflections has a second polarity that is substantially similar to the first polarity, and wherein a second-order reflection from the multiple reflections has a third polarity that is substantially different from the first polarity;
a detector configured to detect:
the first-order reflection based on the second polarity, and
the second-order reflection based on the third polarity; and
a controller communicatively coupled to the detector and the laser source, the controller configured to filter the second-order reflection based at least in part on a difference in the second polarity and the third polarity.

14. The system of claim 13, wherein the controller is further configured to:
instruct the laser source to project the polarized light onto the metallic part; and
instruct the detector to capture an image of the metallic part when the polarized light is projected onto the metallic part.

15. The system of claim 14, wherein the controller is further configured to:
extract, from the image of the metallic part, a first sub image corresponding to the first-order reflection, wherein extraction of the first sub image is in accordance with the second polarity; and
extract, from the image of the metallic part, a second sub image corresponding to the second-order reflection, wherein extraction of the second sub image in accordance with the third polarity, and
wherein the first and second sub images are elements of the image of the metallic part.

16. The system of claim 15, wherein:
the first sub image includes a first intensity information corresponding to the first-order reflection, and wherein the first intensity information is in accordance with the second polarity, and
the second sub image includes a second intensity information corresponding to the second-order reflection, and wherein the second intensity information is in accordance with the third polarity.

17. The system of claim 16, wherein the controller is configured to filter the second-order reflection in accordance with an intensity difference between the first-order reflection and the second-order reflection.

18. The system of claim 13, wherein the controller is further configured to generate a digital representation of the metallic part based on the first-order reflection, and wherein the controller generates the digital representation after filtering the second-order reflection.

19. The system of claim 13, wherein the detector is further configured to:
detect a first angle of linear polarization associated with the first-order reflection; and
detect a second angle of linear polarization associated with the second-order reflection, and
wherein the controller is configured to filter the second-order reflection in accordance with an angle of linear polarization difference between the first-order reflection and the second-order reflection.

20. A system comprising:
a first laser unit configured to generate first polarized light having a first polarity;
a second laser unit configured to generate second polarized light having a second polarity, the second polarity being orthogonal to the first polarity;
an optical lens configured to receive the first polarized light and transmit a first laser line at a first location on a metallic object, the first laser line having a polarity that is substantially similar to the first polarity,
wherein:
the optical lens is also configured to receive the second polarized light and transmit a second laser line at the first location on the metallic object, wherein the second laser line has a polarity that is substantially similar to the second polarity, and
wherein a first-order reflection of the first laser line has a third polarity that is substantially similar to the first polarity, and wherein a second-order reflection of the first laser line has a fourth polarity that is substantially different from the first polarity, and
wherein a first-order reflection of the second laser line has a fifth polarity that is substantially similar to the second polarity, and wherein a second-order reflection of the second laser line has a sixth polarity that is substantially different from the second polarity;
a detector including a camera having an optical filter coupled thereto, the optical filter configured to pass through more light having the first polarity than the second polarity; and
a controller communicatively coupled to the camera, the controller configured to instruct the detector to:
generate the first polarized light at a first time window and capture a first one or more images of the metallic object during the first time window, wherein the first one or more images captured during the first time window includes the first-order reflection of the first laser line having a first intensity and the second-order reflection of the first laser line having a second intensity;
generate the second polarized light at a second time window and capture a second one or more images of the metallic object during the second time window, wherein the second one or more images captured during the second time window includes the first-order reflection of the second laser line having a thief intensity and the second-order reflection of the second laser line having a fourth intensity; and
identify the second-order reflection of the first laser line and second-order reflection of the second laser line based at least in part on a difference between the second intensity and fourth intensity.

21. The system of claim 20, wherein the controller is configured to instruct the detector to filter, from either one of the first one or more images or the second one or more images, the identified second-order reflection of the first laser line and second-order reflection of the second laser line.
